(19) United States
(12) Patent Application Publication
(10) Pub. No.: US 2016/0312006 A1
(43) Pub. Date: Oct. 27, 2016

(54) POLYMER COMPOSITIONS, FILMS, GELS, AND FOAMS CONTAINING SULFONYLIMIDE SALTS, AND ELECTRONIC DEVICES CONTAINING SUCH FILMS, GELS, AND FOAMS

(71) Applicant: RHODIA OPERATIONS, Paris (FR)

(72) Inventors: Chantal BADRE, Millstone, NJ (US); Ahmed ALSAYED, Cherry Hill, NJ (US); Lawrence Alan HOUGH, Philadelphia, PA (US)

(21) Appl. No.: 15/103,767

(22) PCT Filed: Dec. 9, 2014
(86) PCT No.: PCT/US2014/069186

§ 371 Date: Jun. 10, 2016

Related U.S. Application Data
(60) Provisional application No. 61/914,560, filed on Dec. 11, 2013.

(51) Int. Cl. C08K 5/43; H01M 4/137; H01M 10/0565; H01B 1/12; C09D 165/00

(52) U.S. Cl. CPC C08K 5/43; H01B 1/128; C09D 165/00; H01M 10/0565; H01M 4/137

(57) ABSTRACT

Described herein are polymer films, polymer gels, and polymer foams each containing electrically conductive polymers and salts comprising sulfonylimide anions. The polymer films, polymer gels, and polymer foams are each useful as components of electronic devices.

### CROSS REFERENCE TO RELATED APPLICATIONS

This application claims the priority of U.S. Provisional Application No. 61/914,560 filed Dec. 11, 2013, which is hereby incorporated by reference in its entirety.

### FIELD OF THE INVENTION

The present invention relates to polymer compositions, films, gels, and foams, more particularly polymer compositions, films, gels, and foams comprising electrically conductive polymers and salts comprising sulfonylimide anions, and electronic devices containing such polymer films, gels, and foams.

### BACKGROUND

High electrical conductivity is a desirable feature in various electronic devices, including, for example, energy storage devices, transistors, photovoltaic devices, display devices, and the like. Electrical conductivity can be achieved by application of a thin metallic coating such as gold, silver or copper, or a metal oxide coating containing Indium Tin Oxide (ITO) to a substrate. Transparent conductive oxide films such as ITO are used in a wide variety of applications such as, but not limited to, LCDs, OLEDs, solar cells, and the like. ITO films tend to have weak mechanical strength and low flexibility, which makes them fragile and readily damaged during bending. In addition, ITO films are generally applied using vacuum deposition and are therefore not amenable to wet processing. There is a variety of technical approaches for developing ITO substitutes and there are four areas in which these various alternatives compete: price, electrical conductivity, optical transparency, and physical resiliency.

Electrically conductive polymers, such as polythiophene polymers, particularly a polymer blend of poly(3,4-ethylenedioxythiophene) and poly(styrene sulfonate) (“PEDOT-PSS”), have been investigated as possible alternatives to metallic coatings, particularly ITO coatings, for use in various applications requiring high electrical conductivity. The electrical conductivity of electrically conductive polymers is typically lower than that of ITO, but can be enhanced through the use of conductive fillers, such as carbon nanotubes, and dopants. However, the performance of such materials still falls short of that of ITO and trade-offs exist between optimizing the electrical conductivity and optimizing the price, optical transparency, and physical resiliency of components comprising electrically conductive polymers.

There is an ongoing unresolved interest in increasing the electrical conductivity of electrically conductive polymers, more specifically of PEDOT-PSS.

### SUMMARY OF THE INVENTION

In a first aspect, described herein are mixtures comprising:
(a) at least one electrically conductive polymer, and
(b) at least one salt comprising a sulfonylimide anion.

In a second aspect, described herein are mixtures comprising:
(a) at least one electrically conductive polymer, and
(b) at least one salt comprising a sulfonylimide anion dissolved or dispersed in water.

In a third aspect, described herein are mixtures comprising:
(a) at least one electrically conductive polymer, and
(b) at least one salt comprising a sulfonylimide anion dissolved or dispersed in an organic solvent.

In another aspect, described herein are mixtures comprising:
(a) at least one electrically conductive polymer,
(b) at least one salt comprising a sulfonylimide anion, and
(c) at least one ionic liquid.

In another aspect, the present invention is directed to a polymer film, comprising a mixture comprising:
(a) an electrically conductive polymer, and
(b) a salt comprising a sulfonylimide anion.

In yet another aspect, the present invention is directed to a polymer composition, comprising:
(a) a liquid carrier comprising water and at least one water miscible polar organic liquid,
(b) at least one electrically conductive polymer dissolved or dispersed in the liquid carrier, and
(c) at least one salt comprising a sulfonylimide anion dissolved in the liquid carrier.

In yet another aspect, described herein are polymer compositions, comprising:
(a) a first liquid carrier comprising water, at least one water miscible polar organic liquid, at least one ionic liquid or any combination thereof;
(b) at least one electrically conductive polymer dissolved or dispersed in the first liquid carrier, and
(c) at least one salt comprising a sulfonylimide anion.

In yet another aspect, described herein are methods for making a polymer film comprising:
(1) forming a layer of a polymer composition described herein on a substrate, and
(2) removing the liquid carrier from the layer.

In another aspect, described herein are polymer films made by any of the methods described herein.

In a further aspect, described herein are electronic devices, comprising:
(a) an anode layer,
(b) a cathode layer,
(c) an electroactive layer disposed between the anode layer and the cathode layer,
(d) optionally, a buffer layer,
(e) optionally, a hole transport layer, and
(f) optionally, an electron injection layer,
wherein at least one of the anode layer, the cathode layer, and, if present, the buffer layer comprises a polymer film, gel, or foam as described herein.

In another aspect, described herein are batteries, typically battery cells, comprising the polymer films, gels, and foams of the present invention.

The respective polymer film, gel, or foam, or polymer film, gel, or foam component of the electronic device of the present invention typically provide high electrical conductivity and/or high optical transmittance.

### BRIEF DESCRIPTION OF THE DRAWINGS

FIG. 1 shows a schematic diagram of an electronic device according to the present invention.

FIG. 2 is a plot of sheet resistance of films formed from the compositions of the examples described herein, expressed in Ohms per square (“ohms/square”) versus amount of lithium bis(trifluoromethanesulfonyl)imide (Li-TFSI) in the solution, expressed as percent by weight (“wt %”) with respect to the amount of PEDOT:PSS dispersion used.

FIG. 3 shows a plot of the average sheet resistance, expressed in Ohms per square (“ohms/square”), of wet films formed from the coating compositions of examples described herein versus the amount of lithium bis(trifluoromethanesulfonyl)imide (LiTFSI) used, expressed as percent by weight (“wt %”) with respect to the amount of PEDOT:PSS dispersion used.

FIG. 4 shows a plot of the average sheet resistance, expressed in Ohms per square (“ohms/square”), of wet films formed from the coating compositions of examples described herein versus the amount of lithium bis(trifluoromethanesulfonyl)imide (LiTFSI) used, expressed as percent by weight (“wt %”) with respect to the amount of PEDOT:PSS dispersion used.

### DETAILED DESCRIPTION OF THE INVENTION

As used herein, the terms “a”, “an”, or “the” means “one or more” or “at least one” unless otherwise stated.

As used herein, the following terms have the meanings ascribed below:

“acidic group” means a group capable of ionizing to donate a hydrogen ion,

“anode” means an electrode that is more efficient for injecting holes compared to than a given cathode,

“buffer layer” generically refers to electrically conductive or semiconductive materials or structures that have one or more functions in an electronic device, including but not limited to, planarization of an adjacent structure in the device, such as an underlying layer, charge transport and/or charge injection properties, scavenging of impurities such as oxygen or metal ions, and other aspects to facilitate or to improve the performance of the electronic device,

“cathode” means an electrode that is particularly efficient for injecting electrons or negative charge carriers,

“confinement layer” means a layer that discourages or prevents quenching reactions at layer interfaces,

“doped” as used herein in reference to an electrically conductive polymer means that the electrically conductive polymer has been combined with a polymer counterion for the electrically conductive polymer, which polymer counterion is referred to herein as “dopant”, and is typically a polymer acid, which is referred to herein as a “polymer acid dopant”,

“doped electrically conductive polymer” means a polymer blend comprising an electrically conductive polymer and a polymer counterion for the electrically conductive polymer,

“electrically conductive polymer” means any polymer or polymer blend that is inherently or intrinsically, without the addition of electrically conductive fillers such as carbon black or conductive metal particles, capable of electrical conductivity, more typically to any polymer or oligomer that exhibits a bulk specific conductance of greater than or equal to 10⁻⁷ Siemens per centimeter (“S/cm”), unless otherwise indicated, a reference herein to an “electrically conductive polymer” include any optional polymer acid dopant,

“electrically conductive” includes conductive and semi-conductive,

“electroactive” when used herein in reference to a material or structure, means that the material or structure exhibits electronic or electro-radiative properties, such as emitting radiation or exhibiting a change in concentration of electron-hole pairs when receiving radiation,

“electronic device” means a device that comprises one or more layers comprising one or more semiconductor materials and makes use of the controlled motion of electrons through the one or more layers,

“electron injection/transport”, as used herein in reference to a material or structure, means that such material or structure that promotes or facilitates migration of negative charges through such material or structure into another material or structure,

“high-boiling solvent” refers to an organic compound which is a liquid at room temperature and has a boiling point of greater than 100° C.,

“hole transport” when used herein when referring to a material or structure, means such material or structure facilitates migration of positive charges through the thickness of such material or structure with relative efficiency and small loss of charge,

“layer” as used herein in reference to an electronic device, means a coating covering a desired area of the device, wherein the area is not limited by size, that is, the area covered by the layer can, for example, be as large as an entire device, be as large as a specific functional area of the device, such as the actual visual display, or be as small as a single sub-pixel,

“polymer” includes homopolymers and copolymers,

“polymer blend” means a blend of two or more polymers, and

“polymer network” means a three dimensional structure of interconnected segments of one or more polymer molecules, in which the segments are of a single polymer molecule and are interconnected by covalent bonds (a “crosslinked polymer network”), in which the segments are of two or more polymer molecules and are interconnected by means other than covalent bonds, (such as physical entanglements, hydrogen bonds, or ionic bonds) or by both covalent bonds and by means other than covalent bonds (a “physical polymer network”).

As used herein, the terminology “(Cₓ-C_{y})” in reference to an organic group, wherein x and y are each integers, means that the group may contain from x carbon atoms to y carbon atoms per group.

As used herein, the term “halo” means a halogen or halide radical and includes, for example, fluoride (F), chloride (Cl), bromide (Br), iodide (I), and astatide (At).

As used herein, the term “alkyl” means a monovalent straight, branched or cyclic saturated hydrocarbon radical, more typically, a monovalent straight or branched saturated (C₁-C₄₀)hydrocarbon radical, such as, for example, methyl, ethyl, n-propyl, isopropyl, n-butyl, isobutyl, tert-butyl, hexyl, octyl, hexadecyl, octadecyl, eicosyl, behenyl, tricontyl, and tetracontyl. As used herein, the term “cycloalkyl” means a saturated hydrocarbon radical, more typically a saturated (C₅-C₂₂) hydrocarbon radical, that includes one or more cyclic alkyl rings, which may optionally be substituted on one or more carbon atoms of the ring with one or two (C₁-C₆)alkyl groups per carbon atom, such as, for example, cyclopentyl, cycloheptyl, cyclooctyl.

The term “heteroalkyl” means an alkyl group wherein one or more of the carbon atoms within the alkyl group has been replaced by a hetero atom, such as, for example, nitrogen, oxygen, or sulfur.

The term “haloalkyl” means an alkyl radical, more typically a (C₁-C₂₂)alkyl radical, that is substituted with one or more halogen atoms, such as fluorine, chlorine, bromine, and iodine. Examples of haloalkyl groups include, for example, trifluoromethyl, 1H,1H,2H,2H-perfluorooctyl, perfluoroethyl.

As used herein, the term “hydroxyalkyl” means an alkyl radical, more typically a (C₁-C₂₂)alkyl radical, that is substituted with one or more hydroxyl groups, including, for example, hydroxymethyl, hydroxyethyl, hydroxypropyl, and hydroxydecyl.

As used herein, the term “alkoxyalkyl” means an alkyl radical that is substituted with one or more alkoxy substituents, more typically a (C₁-C₂₂)alkyloxy-(C₁-C₆)alkyl radical, including, for example, methoxymethyl, ethoxyethyl, and ethoxybutyl.

As used herein, the term “alkenyl” means an unsaturated straight or branched hydrocarbon radical, more typically an unsaturated straight, branched, (C₂-C₂₂) hydrocarbon radical, that contains one or more carbon-carbon double bonds, including, for example, ethenyl (vinyl), n-propenyl, and iso-propenyl, and allyl.

As used herein, the term “cycloalkenyl” means an unsaturated hydrocarbon radical, typically an unsaturated (C₅-C₂₂) hydrocarbon radical, that contains one or more cyclic alkenyl rings and which may optionally be substituted on one or more carbon atoms of the ring with one or two (C₁-C₆)alkyl groups per carbon atom, including, for example, cyclohexenyl and cycloheptenyl.

As used herein, the term “alkynyl” means an unsaturated straight or branched hydrocarbon radical, more typically an unsaturated straight, branched, (C₂-C₂₂) hydrocarbon radical, that contains one or more carbon-carbon triple bonds, including, for example, ethynyl, propynyl, and butynyl.

As used herein, the term “aryl” means a monovalent unsaturated hydrocarbon radical containing one or more six-membered carbon rings in which the unsaturation may be represented by three conjugated double bonds. Aryl radicals include monocyclic aryl and polycyclic aryl. “Polycyclic aryl” refers to a monovalent unsaturated hydrocarbon radical containing more than one six-membered carbon ring in which the unsaturation may be represented by three conjugated double bonds wherein adjacent rings may be linked to each other by one or more bonds or divalent bridging groups or may be fused together. Aryl radicals may be substituted at one or more carbons of the ring or rings with hydroxyl, cyano, alkyl, alkoxyl, alkenyl, halo, haloalkyl, monocyclic aryl, amino, —(C═O)-alkyl, —(C═O)O-alkyl, —(C═O)-haloalkyl, or —(C═O)-(monocyclic aryl). Examples of aryl radicals include, but are not limited to, phenyl, methylphenyl, isopropylphenyl, tert-butylphenyl, methoxyphenyl, dimethylphenyl, trimethylphenyl, chlorophenyl, trichloromethylphenyl, triisobutyl phenyl, anthracenyl, naphthyl, phenanthrenyl, fluorenyl, and pyrenyl.

As used herein, the term “aralkyl” means an alkyl group substituted with one or more aryl groups, more typically a (C₁-C₁₈)alkyl substituted with one or more (C₆-C₁₄)aryl substituents, including, for example, phenylmethyl (benzyl), phenylethyl, and triphenylmethyl.

As used herein, the term “heterocycle” or “heterocyclic” refers to compounds having a saturated or partially unsaturated cyclic ring structure that includes one or more hetero atoms in the ring. The term “heterocyclyl” refers to a monovalent group having a saturated or partially unsaturated cyclic ring structure that includes one or more hetero atoms in the ring. Examples of heterocyclyl groups include, but are not limited to, morpholinyl, piperadinyl, piperazinyl, pyrrolinyl, pyrazolyl, and pyrrolidinyl.

As used herein, the term “heteroaryl” means a monovalent group having at least one aromatic ring that includes at least one hetero atom in the ring, which may be substituted at one or more atoms of the ring with hydroxyl, alkyl, alkoxyl, alkenyl, halo, haloalkyl, monocyclic aryl, or amino. Examples of heteroaryl groups include, but are not limited to, thienyl, pyrrolyl, pyridinyl, pyrimidinyl, pyrazinyl, triazinyl, pyridazinyl, tetrazolyl, and imidazolyl groups. The term “polycyclic heteroaryl” refers to a monovalent group having more than one aromatic ring, at least one of which includes at least one hetero atom in the ring, wherein adjacent rings may be linked to each other by one or more bonds or divalent bridging groups or may be fused together. Examples of polycyclic heteroaryl groups include, but are not limited to, indolyl and quinolinyl groups.

Any alkyl, haloalkyl, hydroxyalkyl, alkoxyalkyl, alkoxyl, alkenyl, cycloalkenyl, alkynyl, aryl, aralkyl, heterocyclyl, or heteroaryl groups described herein may optionally be substituted at one or more carbon atoms with hydroxyl, cyano, alkyl, alkoxyl, alkenyl, halo, haloalkyl, monocyclic aryl, amino, —(C═O)-alkyl, —(C═O)O-alkyl, —(C═O)-haloalkyl, or —(C═O)-(monocyclic aryl).

As used herein, the term “substantially dry form” refers to a form of a substance having a low amount of bound water molecules. Typically, “substantially dry” means “less than 5 wt % of water”. More typically, “substantially dry” means “less than 3 wt % of water”. Even more typically, “substantially dry” means “less than 1 wt % of water”. Yet even more typically, “substantially dry” means “less than 0.5 wt % of water”.

As used herein, the following terms refer to the corresponding substituent groups:

“amido” is —R¹—C(O)N(R⁶)R⁶,

“amidosulfonate” is —R¹—C(O)N(R⁴)R²—SO₃Z,

“benzyl” is —CH₂—C₆H₅,

“carboxylate” is —R¹—C(O)O—Z or —R¹—O—C(O)—Z,

“ether” is —R¹—(O—R³)ₚ—O—R³,

“ether carboxylate” is —R¹—O—R²—C(O)O—Z or —R¹—O—R²—O—C(O)—Z,

“ether sulfonate” is —R¹—O—R²—SO₃Z,

“ester sulfonate” is —R¹—O—C(O)R²—SO₃Z, and

“urethane” is —R¹—O—C(O)—N(R⁴)₂,

wherein:

each R¹ is absent or alkylene,

each R² is alkylene,

each R³ is alkyl,

each R⁴ is H or an alkyl,

p is 0 or an integer from 1 to 20, and

each Z is H, alkali metal, alkaline earth metal, N(R³)₄ or R³,

wherein any of the above groups may be non-substituted or substituted, and any group may have fluorine substituted for one or more hydrogens, including perfluorinated groups.

As used herein, the term “salt” refers to compounds composed of ions. Typically, salts are composed of related numbers of cations (positively-charged ions) and anions (negatively-charged ions).

Cations include inorganic cations and organic cations. Typically, inorganic cations include alkali metal cations, alkaline earth metal cations, transition metal cations, lanthanide cations, Group 13 (modern IUPAC numbering) cations, Group 14 cations, and Group 15 cations. Examples of alkali metal cations include, but are not limited to, sodium (Na⁺), lithium (Li⁺), potassium (K⁺), rubidium (Rb⁺), and cesium (Cs⁺). Examples of alkaline earth metal cations include, but are not limited to, magnesium (Mg²⁺), calcium (Ca²⁺), strontium (Sr²⁺), and barium (Ba²⁺). Examples of transition metal cations include, but are not limited to, iron(III) (Fe³⁺), cooper(II) (Cu²⁺), silver(I) (Ag⁺), zinc(II) (Zn²⁺), yttrium(III) (Y³⁺), cobalt(II) (Co²⁺), tungsten(III) (W³⁺), zirconium(IV) (Zr⁴⁺), and titanium(IV) (Ti⁴⁺). Examples of lanthanide cations include, but are not limited to, lanthanum(III) (La³⁺), cerium(III) (Ce³⁺), and europium(III) (Eu³⁺). Examples of Group 13 cations include, but are not limited to, aluminum(III) (Al³⁺) and gallium(III) (Ga³⁺). Examples of Group 14 cations include, but are not limited to, tin(II) (Sn²⁺) and tin(IV) (Sn⁴⁺). Examples of Group 15 cations include, but are not limited to, bismuth(III) (Bi³⁺) and antimony(III) (Sb³⁺).

Organic cations are positively-charged species wherein the positive charge(s) is(are) carried by a non-metal atom. Organic cations may contain one or more carbon atoms. Organic cations include nitrogen-based organic cations, phosphorus-based organic cations, carbocation-based organic cations, sulfur-based organic cations, and iodine-based organic cations.

Nitrogen-based organic cations contain one or more nitrogen atoms and the positive charge is carried by at least one nitrogen atom in the cation. Nitrogen-based organic cations include quaternary ammonium cations, nitrogen heterocyclic and nitrogen heteroaromatic cations.

Quaternary ammonium cations include cations of formula VI′:

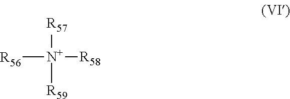

wherein R₅₆-R₅₉ are each, independently, H, alkyl, haloalkyl, cycloalkyl, heteroalkyl, hydroxyalkyl, alkoxyalkyl, alkenyl, cycloalkenyl, aryl, aralkyl, alkylsilyl, alkylsilylsilyl, alkyl-SO₂—, or alkenyl-SO₂—. Alkyl, haloalkyl, cycloalkyl, heteroalkyl, hydroxyalkyl, alkoxyalkyl, alkenyl, cycloalkenyl, aryl, and aralkyl groups may optionally be substituted at one or more carbons with acetoxy (—O(CO)CH₃) groups or carboxyl groups (—(CO)OH). Typically, R₅₆-R₅₉ are each, independently, H, (C₁-C₁₄)alkyl, hydroxyalkyl, alkoxyalkyl, aryl, aralkyl, alkylsilyl, alkylsilylsilyl, alkyl-SO₂—, or alkenyl-SO₂—. More typically, R₅₆-R₅₉ are each, independently, H, methyl, ethyl, acetoxyethyl, n-propyl, isopropyl, n-butyl, hexyl, octyl, dodecyl, tetradecyl, octadecyl, hydroxyethyl, methoxyethyl, (2-methoxyethoxy)ethyl, phenyl, benzyl, trimethylsilyl, tris(trimethylsilyl)silyl, (tert-butyl)dimethylsilyl, trifluoromethylsulfonyl, vinylsulfonyl, or allylsulfonyl. Examples of quaternary ammonium cations include, but are not limited to, ammonium, tetramethyl ammonium, triethyl ammonium, trimethyltetradecyl ammonium, tetrabutyl ammonium, tetrahexyl ammonium, butyltrimethyl ammonium, methyltrioctyl ammonium, tetrakis(decyl)ammonium, tetraoctyl ammonium, tributylmethyl ammonium, bis(2-hydroxyethyl)methyl ammonium, (2-hydroxyethyl)dimethyloctyl ammonium, tris(2-hydroxyethyl)methyl ammonium, (2-hydroxyethyl)trimethyl ammonium, (2-acetoxyethyl)trimethyl ammonium, tetraheptyl ammonium, tetradodecyl ammonium, tetraethyl ammonium, ethyldimethylpropyl ammonium, benzyltrimethyl ammonium, benzyldimethyltetradecyl ammonium, benzyltributyl ammonium tris(2-(2-methoxyethoxy)ethyl) ammonium, dimethyldioctadecyl ammonium, 1-carboxy-N,N,N-trimethylmethanaminium, phenyldimethyl ammonium, diisopropylethyl ammonium, bis(trifluoromethylsulfonyl)phenyl ammonium, (trifluoromethylsulfonyl)phenyl ammonium, bis(trifluoromethylsulfonyl)propyl ammonium, bis(trifluoromethylsulfonyl)butyl ammonium, bis(trifluoromethylsulfonyl)ethyl ammonium, bis(trifluoromethylsulfonyl)(trimethylsilyl) ammonium, bis(trifluoromethylsulfonyl)-tris(trimethyl)silyl ammonium, bis(trifluoromethylsulfonyl)-(tert-butyl)dimethylsilyl ammonium, allylsulfonyltrimethylsulfonyl ammonium, and vinylsulfonyltrimethylsulfonyl ammonium cations.

Nitrogen heterocyclic and nitrogen heteroaromatic cations include 5-8-membered ring structures and may contain heteroatoms other than nitrogen.

Nitrogen heterocyclic cations include pyrazolium, such as, for example, 1-butyl-2,3,5-trimethylpyrazolium, 1,2,4-trimethylpyrazolium, and 1-butyl-2-methylpyrazolium cations, pyrrolinium cations, thiazolium cations, oxazolium cations, and cations of formula VI:

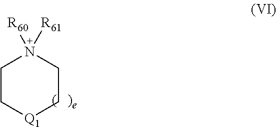

wherein R₆₀ and R₆₁ are each, independently H, alkyl, haloalkyl, cycloalkyl, heteroalkyl, hydroxyalkyl, alkoxyalkyl, alkenyl, cycloalkenyl, aryl, or aralkyl; e is an integer from 0 to 3; and Q₁ is —NH—, —O—, or —CH₂—. Typically, R₆₀ and R₆₁ are each, independently, H, (C₁-C₁₂)alkyl, hydroxyalkyl, alkoxyalkyl. More typically, R₆₀ and R₆₁ are each, independently, H, methyl, ethyl, n-propyl, n-butyl, hexyl, octyl, dodecyl, ethoxyethyl, ethoxymethyl, and methoxypropyl. Even more typically, Q₁ is —O—, or —CH₂— and e is 0 or 1.

Typically, cations of formula VI include cations of formula VII:

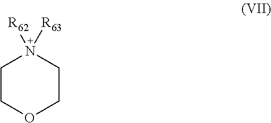

wherein R₆₂ and R₆₃ are each, independently H, alkyl, haloalkyl, cycloalkyl, heteroalkyl, hydroxyalkyl, alkoxyalkyl, alkenyl, cycloalkenyl, aryl, or aralkyl. Typically, R₆₂ and R₆₃ are each, independently, H, (C₁-C₁₂)alkyl, hydroxyalkyl, alkoxyalkyl. More typically, R₆₂ and R₆₃ are each, independently, H, methyl, ethyl, n-propyl, n-butyl, hexyl, octyl, dodecyl, ethoxyethyl, ethoxymethyl, and methoxypropyl. Examples of cations of formula VII include, but are not limited to, N,N-dimethyl-morpholinium, N,N-diethyl-morpholinium, N-ethoxymethyl-N-methyl-morpholinium cations.

Cations of formula VI also include cations of formula VIII:

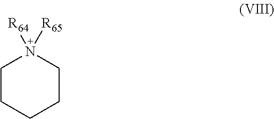

wherein R₆₄ and R₆₅ are each, independently H, alkyl, haloalkyl, cycloalkyl, heteroalkyl, hydroxyalkyl, alkoxyalkyl, alkenyl, cycloalkenyl, aryl, or aralkyl. Typically, R₆₄ and R₆₅ are each, independently, H, (C₁-C₁₂)alkyl, hydroxyalkyl, alkoxyalkyl. More typically, R₆₄ and R₆₅ are each, independently, H, methyl, ethyl, n-propyl, n-butyl, hexyl, octyl, dodecyl, ethoxyethyl, ethoxymethyl, and methoxypropyl. Examples of cations of formula VIII include, but are not limited to, 1-butyl-1-methyl-piperidinium, 1-methyl-1-propyl-piperidinium, 1,1-dimethyl-piperidinium, 1-ethoxyethyl-1-methyl-piperidinium, 1-hexyl-1-methyl-piperidinium, and 1-methyl-1-octyl-piperidinium cations.

Cations of formula VI include cations of formula IX:

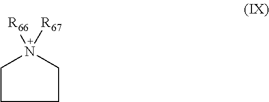

wherein R₆₆ and R₆₇ are each, independently H, alkyl, haloalkyl, cycloalkyl, heteroalkyl, hydroxyalkyl, alkoxyalkyl, alkenyl, cycloalkenyl, aryl, or aralkyl. Typically, R₆₆ and R₆₇ are each, independently, H, (C₁-C₁₂)alkyl, hydroxyalkyl, alkoxyalkyl. More typically, R₆₆ and R₆₇ are each, independently, H, methyl, ethyl, n-propyl, n-butyl, hexyl, octyl, dodecyl, ethoxyethyl, ethoxymethyl, and methoxypropyl. Examples of cations of formula IX include, but are not limited to, 1-butyl-1-methyl-pyrrolidinium, 1-ethyl-1-methyl-pyrrolidinium, 1-methyl-1-propyl-pyrrolidinium, 1,1-dimethyl-pyrrolidinium, 1-ethoxyethyl-1-methyl-pyrrolidinium, 1-hexyl-1-methyl-pyrrolidinium, and 1-methyl-1-octyl-pyrrolidinium cations.

Nitrogen heteroaromatic cations include imidazolium, pyridazinium, pyrazinium, pyridinium, triazolium, pyrrolium cations, such as, for example, 1,1-dimethyl-pyrrolium, 1-methyl-1-pentyl-pyrrolium cations; and triazine ammonium cations, such as, for example, 1,3,5-triazin-2,4,6-triaminium, 6-amino-1,3,5-triazin-2,4-diaminium, and 4,6-diamino-1,3,5-triazin-2-aminium cations.

Imidazolium cations include cations of formula X:

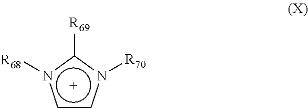

wherein R₆₈, R₆₉, and R₇₀ are each, independently, independently H, alkyl, haloalkyl, cycloalkyl, heteroalkyl, hydroxyalkyl, alkoxyalkyl, sulfoalkyl, alkenyl, cycloalkenyl, aryl, or aralkyl. Typically, R₆₈, R₆₉, and R₇₀ are each, independently, H, (C₁-C₁₄)alkyl, hydroxyalkyl, alkoxyalkyl, sulfoalkyl, (C₂-C₁₄)alkenyl, aryl, or aralkyl. More typically, R₆₈, R₆₉, and R₇₀ are each, independently, H, methyl, ethyl, n-propyl, n-butyl, isobutyl, pentyl, hexyl, heptyl, octyl, dodecyl, tetradecyl, hydroxyethyl, ethoxyethyl, ethoxymethyl, methoxypropyl, sulfopropyl, vinyl, phenyl, or benzyl. Examples of imidazolium cations include, but are not limited to, 1,3-dimethyl-imidazolium, 1-benzyl-3-methyl-imidazolium, 1-butyl-3-methyl-imidazolium, 1-ethyl-3-methyl-imidazolium, 1-hexyl-3-methyl-imidazolium, 1-methyl-3-propyl-imidazolium, 1-methyl-3-octyl-imidazolium, 1-methyl-3-tetradecyl-imidazolium, 1-methyl-3-phenyl-imidazolium, 1,2,3-trimethyl-imidazolium, 1,2-methyl-3-octyl-imidazolium, 1-butyl-2,3-dimethyl-imidazolium, 1-hexyl-2,3-methyl-imidazolium, 1-(2-hydroxyethyl)-2,3-dimethyl-imidazolium, 1-pentyl-3-methyl-imidazolium, 1-isobutyl-3-methyl-imidazolium, 3-methyl-1-pentyl-imidazolium, and 1-heptyl-3-methyl-imidazolium cations.

Pyridinium cations include cations having formula XI:

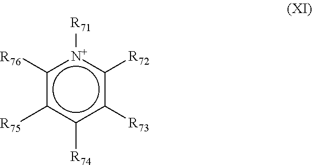

wherein R₇₁-R₇₆ are each, independently H, alkyl, haloalkyl, cycloalkyl, heteroalkyl, hydroxyalkyl, alkoxyalkyl, sulfoalkyl, alkenyl, cycloalkenyl, aryl, or aralkyl. Typically, R₇₁-R₇₆ are each, independently, H, (C₁-C₁₄)alkyl, hydroxyalkyl, alkoxyalkyl, sulfoalkyl, (C₂-C₁₄)alkenyl, aryl, or aralkyl. More typically, R₇₁-R₇₆ are each, independently, H, methyl, ethyl, n-propyl, n-butyl, isobutyl, pentyl, hexyl, heptyl, octyl, dodecyl, tetradecyl, hydroxyethyl, hydroxypropyl, ethoxyethyl, ethoxymethyl, methoxypropyl, sulfopropyl, vinyl, phenyl, and benzyl. Examples of pyridinium cations include, but are not limited to, N-butyl-pyridinium, N-hexyl-pyridinium cations, N-butyl-4-methyl-pyridinium, N-butyl-3-methyl-pyridinium, and N-(3-hydroxypropyl)pyridinium cations.

Phosphorus-based organic cations include phosphonium cations having formula XI′:

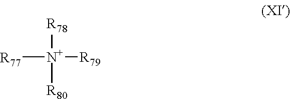

wherein R₇₇-R₈₀ are each, independently, H, alkyl, haloalkyl, cycloalkyl, heteroalkyl, hydroxyalkyl, alkoxyalkyl, alkenyl, cycloalkenyl, aryl, or aralkyl. Typically, R₇₇-R₈₀ are each, independently, H, (C₁-C₁₄)alkyl, hydroxyalkyl, alkoxyalkyl, or aryl. More typically, R₇₇-R₈₀ are each, independently, H, methyl, ethyl, n-propyl, n-butyl, hexyl, octyl, dodecyl, tetradecyl, hydroxymethyl, or phenyl. Examples of phosphonium cations include, but are not limited to, tributyloctyl phosphonium, tributyldodecyl phosphonium, tetrabutyl phosphonium, tributylmethyl phosphonium, triethylmethyl phosphonium, tetraphenyl phosphonium, tetrakis(hydroxymethyl) phosphonium, and trihexyl(tetradecyl)phosphonium cations.

Carbocation-based organic cations include for example, guanidinium and cyclopropenylium cations.

Guanidinium cations include cations having formula XII:

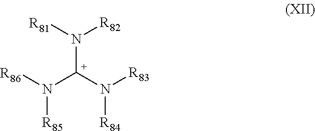

wherein R₈₁, R₈₂, R₈₃, and R₈₆ are each, independently H, alkyl, haloalkyl, cycloalkyl, heteroalkyl, hydroxyalkyl, alkoxyalkyl, alkenyl, cycloalkenyl, aryl, or aralkyl; and R₈₄ and R₈₅ are each, independently, H, alkyl, haloalkyl, cycloalkyl, heteroalkyl, hydroxyalkyl, alkoxyalkyl, alkenyl, cycloalkenyl, aryl, or aralkyl; or R₈₄ and R₈₅ together form an alkylene group. Typically, R₈₁, R₈₂, R₈₃, and R₈₆ are each, independently, H, (C₁-C₁₄)alkyl, hydroxyalkyl, alkoxyalkyl, (C₂-C₁₄)alkenyl, aryl, or aralkyl; and R₈₄ and R₈₅ are each, independently, H, (C₁-C₁₄)alkyl, hydroxyalkyl, alkoxyalkyl, (C₂-C₁₄)alkenyl, aryl, or aralkyl; or R₈₄ and R₈₅ together form a (C₂-C₈)alkylene group. More typically, R₈₁, R₈₂, R₈₃, and R₈₆ are each, independently, H, methyl, ethyl, n-propyl, n-butyl, isobutyl, pentyl, hexyl, or methoxyethyl; and R₈₄ and R₈₅ are each, independently, H, methyl, ethyl, n-propyl, n-butyl, isobutyl, pentyl, hexyl, or methoxyethyl; or R₈₄ and R₈₅ together form an ethylene group. Examples of guanidinium cations include, but are not limited to, guanidinium, tetramethylguanidinium, hexamethylguanidium, N,N,N′,N′-tetrahexyl-N″,N″-dimethylguanidinium, 2-amino-1,3-dimethyl-4,5-dihydro-1H-imidazol-3-ium, 2-((2-methoxyethyl)(methyl)amino)-1,3-dimethyl-4,5-dihydro-1H-imidazol-3-ium, 2-(ethyl(2-methoxyethyl)amino)-1,3-dimethyl-4,5-dihydro-1H-imidazol-3-ium, N-((dimethylamino)((2-methoxyethyl)(methyl)amino)methylene)-N-methylmethanaminium, 2-(ethyl(methyl)amino)-1,3-dimethyl-4,5-dihydro-1H-imidazol-3-ium, and 1,3-dimethyl-2-(methyl(propyl)amino)-4,5-dihydro-1H-imidazol-3-ium cations.

Cyclopropenylium cations include cations having formula XIII:

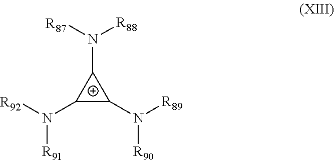

wherein R₈₇-R₉₂ are each, independently H, alkyl, haloalkyl, cycloalkyl, heteroalkyl, hydroxyalkyl, alkoxyalkyl, alkenyl, cycloalkenyl, aryl, or aralkyl. Typically, R₈₇-R₉₂ are each, independently, H, (C₁-C₁₄)alkyl, hydroxyalkyl, alkoxyalkyl, (C₂-C₁₄)alkenyl, aryl, or aralkyl. More typically, R₈₇-R₉₂ are each, independently, H, methyl, ethyl, n-propyl, n-butyl, isobutyl, pentyl, or hexyl. Examples of cyclopropenylium cations include, but are not limited to, 1,2,3-tris(diethylamino)-cyclopropenylium and 1,2,3-tris(dimethylamino)-cyclopropenylium cations.

Sulfur-based organic cations include sulfonium cations having formula XIII′:

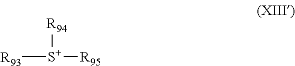

wherein R₉₃, R₉₄, and R₉₅ are each, independently, H, alkyl, haloalkyl, cycloalkyl, heteroalkyl, hydroxyalkyl, alkoxyalkyl, alkenyl, cycloalkenyl, aryl, or aralkyl. Typically, R₉₃, R₉₄, and R₉₅ are each, independently, H, (C₁-C₁₄)alkyl, (C₃-C₆)cycloalkyl, hydroxyalkyl, alkoxyalkyl, (C₂-C₁₄)alkenyl, aryl, or aralkyl. More typically, R₉₃, R₉₄, and R₉₅ are each, independently, H, methyl, ethyl, n-propyl, n-butyl, isobutyl, pentyl, cyclopropyl, and phenyl. Examples of sulfonium cations include, but are not limited to, triethylsulfonium, cyclopropyldiphenyl sulfonium, and trimethyl sulfonium cations.

Iodine-based organic cations include iodonium cations have formula XXIII:

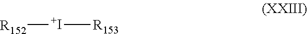

wherein R₁₅₂ and R₁₅₃ are each, independently, alkyl, haloalkyl, cycloalkyl, heteroalkyl, hydroxyalkyl, alkoxyalkyl, alkenyl, cycloalkenyl, aryl, or aralkyl. Typically, R₁₅₂ and R₁₅₃ are each, indendently, an aryl group. More typically, R₁₅₂ and R₁₅₃ are each, independently, phenyl, p-methylphenyl (tolyl), p-isopropylphenyl (cumyl), or p-(tert-butyl)phenyl. Examples of iodonium cations include, but are not limited to, diphenyliodonium, (4-isopropylphenyl)(p-tolyl)iodonium, and bis(4-(tert-butyl)phenyl)iodonium cations.

Anions are negatively-charged moieties and include, for example, halogenoaluminate(III) anions, such as tetrachloroaluminate, chlorate anions, cyanate anions, such as thiocyanate, cyanate, and isocyanate anions, halide anions, such as fluoride, chloride, bromide, and iodide anions, nitrate anions, dicyanamide anions, fluorohydrogenate anions, such as, for example, poly(hydrogen fluoride) fluoride anions, fluorometallate anions, such as, for example, oxopentafluorotungsten anions, sulfonylimide anions, and anions represented by formula XIV:

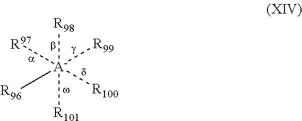

wherein
bonds α, β, γ, δ, and ω, are each, independently, present or absent;

### A is B, C, O, or P;

R₉₆-R₁₀₁ are each, independently, halogen, cyano, alkyl, haloalkyl, cycloalkyl, heteroalkyl, hydroxyalkyl, alkoxyalkyl, alkenyl, cycloalkenyl, aryl, aralkyl, —(CO)—O⁻, —(CO)—OR₁₀₂, —(CO)—R₁₀₃, —C(R₁₀₄)═C—(CO)—R₁₀₅, —(PO)(OR₁₀₆)₂, —(PO)(OR₁₀₇)(O⁻), —(PO)(O⁻)₂, —(SO₂)—O⁻, —(SO₂)—OR₁₀₈, —(SO₂)—R₁₀₉, or —(SO₂)—NH₂;
wherein each occurrence of R₁₀₂, R₁₀₃, R₁₀₄, R₁₀₅, R₁₀₆, R₁₀₇, R₁₀₈, and R₁₀₉, are each, independently, H, halogen, alkyl, haloalkyl, cycloalkyl, heteroalkyl, hydroxyalkyl, alkoxyalkyl, alkenyl, cycloalkenyl, aryl, or aralkyl,
   provided that
when A is B, bonds α, β, and γ are present, R₉₇, R₉₈, R₉₉ are present, and bonds δ, and ω are absent, and R₁₀₀ and R₁₀₁ are absent;
when A is C, bonds α and β are present, R₉₇ and R₉₈ are present, and bonds γ, δ, and ω are absent, and R₉₉, R₁₀₀, and R₁₀₁ are absent;
when A is O, bonds α, β, γ, δ, and ω are absent, and R₉₆-R₁₀₁ are absent; and
when A is P, bonds α, β, γ, δ, and ω are present, and R₉₆-R₁₀₁ are present.

Anions of formula XIV include anions having formula XV:

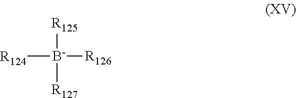

wherein R₁₂₄-R₁₂₇ are each, independently, halogen, cyano, alkyl, haloalkyl, cycloalkyl, heteroalkyl, hydroxyalkyl, alkoxyalkyl, alkenyl, cycloalkenyl, aryl, or aralkyl. Alkyl, haloalkyl, cycloalkyl, heteroalkyl, hydroxyalkyl, alkoxyalkyl, alkenyl, cycloalkenyl, aryl, and aralkyl groups may be substituted at one or more carbons with halogen, cyano, thio, alkyl, cycloalkyl, heteroalkyl, hydroxyalkyl, alkoxyalkyl, alkenyl, cycloalkenyl, aryl, aralkyl, or alkylsilyl. Typical anions of formula (XV) include, for example, tetrafluoroborate, tetracyanoborate, tetrakis-(p-(dimethyl(1H, 1H, 2H, 2H-perfluorooctyl)silyl)phenyl)borate, alkyltrifluoroborate, perfluoroalkyltrifluoroborate, and alkenyltrifluoroborate anions.

Anions of formula XIV also include anions having formula XVI:

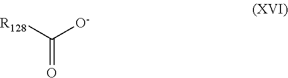

wherein R₁₂₈ is —O⁻, —OR₁₂₉, or —R₁₃₀, wherein R₁₂₉ and R₁₃₀ are each H, halogen, alkyl, haloalkyl, cycloalkyl, heteroalkyl, hydroxyalkyl, alkoxyalkyl, alkenyl, cycloalkenyl, aryl, or aralkyl. Alkyl, haloalkyl, cycloalkyl, heteroalkyl, hydroxyalkyl, alkoxyalkyl, alkenyl, cycloalkenyl, aryl, or aralkyl groups may be substituted at one or more carbons with halogen, cyano, thio, alkyl, cycloalkyl, heteroalkyl, hydroxyalkyl, alkoxyalkyl, alkenyl, cycloalkenyl, aryl, aralkyl, or alkylsilyl. Examples of anions of formula XVI include carbonate, hydrogen carbonate, methylcarbonate, salicylate, thiosalicylate, lactate, acetate, trifluroacetate, and formate anions.

Anions of formula XIV further include anions having formula XVII:

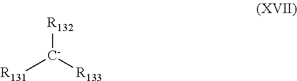

wherein R₁₃₁, R₁₃₂, and R₁₃₃ are each, independently, halogen, cyano, alkyl, haloalkyl, cycloalkyl, heteroalkyl, hydroxyalkyl, alkoxyalkyl, alkenyl, cycloalkenyl, aryl, aralkyl, or —(SO₂)—R₁₃₄, wherein R₁₃₄ is H, halogen, alkyl, haloalkyl, cycloalkyl, heteroalkyl, hydroxyalkyl, alkoxyalkyl, alkenyl, cycloalkenyl, aryl, or aralkyl. Alkyl, haloalkyl, cycloalkyl, heteroalkyl, hydroxyalkyl, alkoxyalkyl, alkenyl, cycloalkenyl, aryl, or aralkyl groups may be substituted at one or more carbons with halogen, cyano, thio, alkyl, cycloalkyl, heteroalkyl, hydroxyalkyl, alkoxyalkyl, alkenyl, cycloalkenyl, aryl, aralkyl, or alkylsilyl. Examples of anions of formula XVII include tricyanomethanide, tris[2,2,2-trifluoroethoxy(sulfonyl)]methanide, and tris[trifluoromethyl(sulfonyl)]methanide.

Anions of formula XIV include anions having formula XIX:

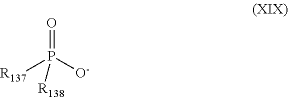

wherein R₁₃₇ and R₁₃₈ are each, independently, —OR₁₃₉ or —O⁻, wherein R₁₃₉ is H, halogen, alkyl, haloalkyl, cycloalkyl, heteroalkyl, hydroxyalkyl, alkoxyalkyl, alkenyl, cycloalkenyl, aryl, or aralkyl. Examples of anions of formula XIX include, but are not limited to, phosphate (PO₄³⁻), monohydrogen phosphate (HPO₄²⁻), dihydrogen phosphate (H₂PO₄⁻), diethyl phosphate and dibenzyl phosphate.

Anions of formula XIV also include anions having formula XX:

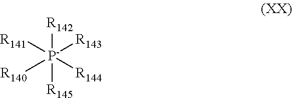

wherein R₁₄₀-R₁₄₅ are each, independently, halogen, cyano, alkyl, haloalkyl, cycloalkyl, heteroalkyl, hydroxyalkyl, alkoxyalkyl, alkenyl, cycloalkenyl, aryl, aralkyl. Alkyl, haloalkyl, cycloalkyl, heteroalkyl, hydroxyalkyl, alkoxyalkyl, alkenyl, cycloalkenyl, aryl, or aralkyl groups may be substituted at one or more carbons with halogen, cyano, thio, alkyl, cycloalkyl, heteroalkyl, hydroxyalkyl, alkoxyalkyl, alkenyl, cycloalkenyl, aryl, aralkyl, or alkylsilyl. Typically, R₁₄₀-R₁₄₅ are each, independently, halogen or alkyl. More typically, R₁₄₀-R₁₄₅ are each, independently, fluorine or haloalkyl. Examples of anions of formula XX include, but are not limited to, hexafluorophosphate, di(trifluoromethyl)tetrafluorophosphate, tris(trifluoromethyl)trifluorophosphate, tris(perfluoroalkyl)trifluorophosphate, such as tris(perfluoroethyl)trifluorophosphate, tetra(trifluoromethyl)difluorophosphate, penta(trifluoromethyl)fluorphosphate, and hexa(trifluoromethylphosphate anions.

Anions of formula XIV further include anions having formula XXI:

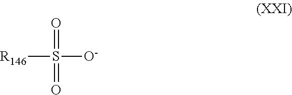

wherein R₁₄₆ is —O—, —OR₁₄₇, —R₁₄₈, or —NH₂, wherein R₁₄₇ and R₁₄₈ are each H, halogen, alkyl, haloalkyl, cycloalkyl, heteroalkyl, hydroxyalkyl, alkoxyalkyl, alkenyl, cycloalkenyl, aryl, or aralkyl. Examples of anions of formula XXI include, but are not limited to, sulfate (SO₄²⁻), hydrogen sulfate (HSO₄⁻), and (C₁-C₁₂)alkylsulfates, such as methylsulfate and octylsulfate, (C₁-C₁₂)alkylsulfonate anions, such trifluoromethanesulfonate, perfluoroethylsulfonate and methanesulfonate, and arylsulfonate anions, such as tosylate.

Anions of formula XIV yet further include anions having formula XXII:

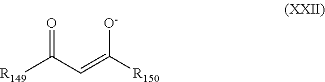

wherein R₁₄₉ and R₁₅₀ each, independently, H, halogen, alkyl, haloalkyl, cycloalkyl, heteroalkyl, hydroxyalkyl, alkoxyalkyl, alkenyl, cycloalkenyl, aryl, or aralkyl. Alkyl, haloalkyl, cycloalkyl, heteroalkyl, hydroxyalkyl, alkoxyalkyl, alkenyl, cycloalkenyl, aryl, or aralkyl groups may be substituted at one or more carbons with halogen, cyano, thio, alkyl, cycloalkyl, heteroalkyl, hydroxyalkyl, alkoxyalkyl, alkenyl, cycloalkenyl, aryl, aralkyl, or alkylsilyl. Examples of anions of formula XXII include, but are not limited to, perfluoroalkyl β-diketonate anions, such as, for example, 6,6,7,7,8,8,8-heptafluoro-2,2-dimethyl-3,5-octanedionate, 1,1,1,5,5,5-hexafluoro-2,4-pentanedionate, and 4,4,4-trifluoro-1-(2-thienyl)-1,3-butanedionate anions.

Sulfonylimide anions include anions represented by formula XVIII:

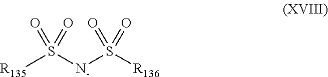

wherein R₁₃₅ and R₁₃₆ are each, independently, alkyl, haloalkyl, hydroxyalkyl, alkoxyalkyl, alkoxyl, alkenyl, cycloalkenyl, alkynyl, aryl, aralkyl, heterocyclyl, or heteroaryl. Typically, R₁₃₅ and R₁₃₆ are each, independently, haloalkyl or alkenyl. More typically, R₁₃₅ and R₁₃₆ are each, independently, trifluoromethyl, difluoromethyl, perfluoroethyl, allyl, or vinyl. Examples of sulfonylimide anions of formula XVIII include, but are not limited to, bis(alkylsulfonyl)imide anions, such as bis(trifluoromethylsulfonyl)imide and bis(difluoromethylsulfonyl)imide anions; (allylsulfonyl)((trifluoromethyl)sulfonyl)imide anions; ((trifluoromethyl)sulfonyl)((4-vinylphenyl)sulfonyl)imide anions; ((trifluoromethyl)sulfonyl)(vinylsulfonyl)imide anions.

In some embodiments, the polymer composition, polymer film, polymer gel, polymer foam, or polymer film, gel, or foam component of the electronic device of the present invention comprises at least one salt comprising a sulfonylimide anion. In an embodiment, the sulfonylimide anion is represented by formula XVIII.

In one embodiment, the at least one salt comprising a sulfonylimide anion comprises an inorganic cation or an organic cation. In one embodiment, the at least one salt comprising a sulfonylimide anion comprises a lithium cation, cation of formula VI′, cation of formula X, cation of formula XI, cation of formula XI′, cation of formula XII, or any combination thereof.

In one embodiment, the at least one salt comprising a sulfonylimide anion comprises lithium cation. In an embodiment, the at least one salt comprising a sulfonylimide anion is lithium bis(trifluoromethanesulfonyl)imide.

In one embodiment, the at least one salt comprising a sulfonylimide anion comprises a cation of formula VI′ selected from tetrabutylammonium, tributylmethylammonium, diisopropylethylammonium, (2-acetoxyethyl)trimethylammonium, tris(2-(2-methyoxyethoxy)ethyl)ammonium or any combination thereof.

In one embodiment, the at least one salt comprising a sulfonylimide anion comprises a cation of formula XII selected from guanidinium, tetramethylguanidinium, or any combination thereof.

In one embodiment, the at least one salt comprising a sulfonylimide anion comprises a cation of formula X selected from 1-butyl-3-methylimidazolium or 1-ethyl-3-methyl-imidazolium.

In one embodiment, the at least one salt comprising a sulfonylimide anion comprises a cation of formula XI′ selected from tributyloctylphosphonium, tributyldodecylphosphonium, or any combination thereof.

In one embodiment, the at least one salt comprising a sulfonylimide anion comprises a cation of formula XI selected N-butyl-pyridinium, N-hexyl-pyridinium cations, N-butyl-4-methyl-pyridinium, N-butyl-3-methyl-pyridinium, and N-(3-hydroxypropyl)pyridinium cations. In a further embodiment, the at least one salt comprising a sulfonylimide anion comprises N-butylpyridinium cation.

In one embodiment, respective polymer film of the present invention and polymer film component of the electronic device of the present invention each comprise, based on 100 parts by weight (“pbw”) of the polymer film:
(i) from about 1 pbw to about 99.9 pbw, more typically from about 10 pbw to about 90 pbw, and even more typically from about 10 pbw to about 80 pbw of the electrically conductive polymer, and
(ii) from about 0.1 to about 99 pbw, more typically from about 10 to about 90 pbw, and even more typically from about 20 to about 90 pbw of the at least one salt comprising a sulfonylimide anion,
   wherein the ratio of the total amount by weight of the at least one salt comprising a sulfonylimide anion in such film to the total amount by weight of the electrically conductive polymer in such film is typically from greater than 0:1 to about 20:1, more typically from about 0.1:1 to 10:1.

In one embodiment of the respective polymer film, gel, or foam of the present invention and polymer film, gel, or foam component of the electronic device of the present invention, the polymer network is a physical polymer network formed by non-crosslinked molecules of the electrically conductive polymer.

In one embodiment of the respective polymer film, gel, or foam of the present invention and polymer film, gel, or foam component of the electronic device of the present invention, the polymer network is a crosslinked polymer network.

In one embodiment, the electrically conductive polymer of the respective polymer film, gel, or foam of the present invention and polymer film, gel, or foam component of the electronic device of the present invention forms a polymer network and polymer network is impregnated with the salt comprising a sulfonylimide anion.

In one embodiment, the polymer composition of the present invention comprises, based on 100 pbw of the polymer composition:
(a) from greater than 0 to less than 100 pbw, more typically from about 50 to less than 100 pbw, even more typically from about 90 to about 99.5 pbw of liquid carrier,
(b) from greater than 0 to less than 100 pbw, more typically from greater than 0 to about 50 pbw, even more typically from 0.5 to about 10 pbw, of the mixture of electrically conductive polymer and at least one salt comprising a sulfonylimide anion, comprising, based on 100 pbw of the total amount of the electrically conductive polymer and the at least one salt comprising a sulfonylimide anion;
   (i) from about 1 to about 99.9 pbw, more typically from about 10 to about 90 pbw, and even more typically from about 10 to about 80 pbw of the electrically conductive polymer, and
   (ii) from about 0.1 to about 99 pbw, more typically from about 10 to about 90 pbw, and even more typically from about 20 to about 90 pbw of the at least one salt comprising a sulfonylimide anion.

In one embodiment, the polymer composition of the present invention is a polymer dispersion, wherein the liquid carrier component of the dispersion may be any liquid in which the electrically conductive polymer component of the composition is insoluble, but within which the electrically conductive polymer component of the composition is dispersible. In one embodiment, the liquid carrier of the polymer composition of the present invention is an aqueous medium that comprises water. In one embodiment, the liquid carrier is an aqueous medium that consists essentially of water. In one embodiment, the liquid carrier is an aqueous medium that consists of water. In one embodiment, the liquid carrier of the polymer composition of the present invention is a non-aqueous medium that comprises one or more water miscible organic liquids. In one embodiment, the liquid carrier of the polymer composition of the present invention is an aqueous medium that comprises water and, optionally, one or more water miscible organic liquids, and the electrically conductive polymer is dispersible in the aqueous medium. Suitable water miscible organic liquids include polar aprotic organic solvents, such as, for example methanol, ethanol, and propanol. In one embodiment, the liquid carrier comprises, based on 100 pbw of the liquid medium, from about 10 to 100 pbw, more typically from about 50 pbw to 100 pbw, and even more typically, from about 90 to 100 pbw, water and from 0 pbw to about 90 pbw, more typically from 0 pbw to about 50 pbw, and even more typically from 0 pbw to about 10 pbw of one or more water miscible organic liquids.

In one embodiment, the polymer composition is a polymer solution, wherein the liquid carrier component of the composition may be any liquid in which the electrically conductive polymer component of the composition is soluble. In one embodiment, the liquid carrier is a non-aqueous liquid medium and the electrically conductive polymer is soluble in and is dissolved in the non-aqueous liquid medium. Suitable non-aqueous liquid media include organic liquids that have a boiling point of less than 120° C., more typically, less than or equal to about 100° C., selected, based on the choice of electrically conductive polymer, from non-polar organic solvents, such as hexanes, cyclohexane, benzene, toluene, chloroform, and diethyl ether, polar aprotic organic solvents, such as dichloromethane, ethyl acetate, acetone, and tetrahydrofuran, polar protic organic solvents, such as methanol, ethanol, and propanol, as well as mixtures of such solvents.

In one embodiment, the liquid carrier may optionally further comprise, based on 100 pbw of the polymer composition of the present invention, from greater than 0 pbw to about 15 pbw, more typically from about 1 pbw to about 10 pbw, of an organic liquid selected from high boiling polar organic liquids, typically having a boiling point of at least 120° C., more typically from diethylene glycol, meso-erythritol, 1,2,3,4,-tetrahydroxybutane, 2-nitroethanol, glycerol, sorbitol, dimethyl sulfoxide, tetrahydrofurane, dimethyl formamide, and mixtures thereof.

In one embodiment, the polymer gel of the present invention comprises, based on 100 pbw of the gel,
(a) from about 2 pbw to about 90 pbw of a polymer network, said network comprising, based on 100 pbw of said network:
   (i) from about 10 to about 40 pbw, more typically from about 15 to about 35 pbw, and even more typically from about 20 to about 35 pbw of the electrically conductive polymer, and
   (ii) from about 60 to about 90 pbw, more typically from about 65 to about 85 pbw, and even more typically from about 65 to about 80 pbw of the at least one salt comprising a sulfonylimide anion, and
(b) from about 10 pbw to about 98 pbw of an aqueous liquid medium.

In one embodiment of the polymer gel of the present invention, the ratio of the total amount by weight of the at least one salt comprising sulfonylimide anion in such gel to the total amount by weight of the electrically conductive polymer in such gel is typically from about 1.5:1 to about 45:1, more typically from 1.7:1 to 20:1, even more typically from about 1.7:1 to about 10:1, and still more typically from 2:1 to 8:1.

In one embodiment, the polymer gel of the present invention comprises, based on 100 pbw of the gel,
(a) from about 2 pbw to about 90 pbw of a polymer network, said network comprising, based on 100 pbw of said network:
   (i) from about 10 to about 40 pbw, more typically from about 15 to about 35 pbw, and even more typically from about 20 to about 35 pbw of the electrically conductive polymer, and
   (ii) from about 60 to about 90 pbw, more typically from about 65 to about 85 pbw, and even more typically from about 65 to about 80 pbw of the at least one salt comprising a sulfonylimide anion, and
(b) from about 10 pbw to about 98 pbw of an aqueous liquid medium, and
   the ratio of the total amount by weight of the at least one salt comprising a sulfonylimide anion in such gel to the total amount by weight of the electrically conductive polymer in such gel is typically from about 1.5:1 to about 45:1, more typically from 1.7:1 to 20:1, even more typically from about 1.7:1 to about 10:1, and still more typically from 2:1 to 8:1.

In one embodiment, the polymer network of the polymer gel of the present invention comprises a reaction product of the electrically conductive polymer and the at least one salt comprising a sulfonylimide anion. In one embodiment, the polymer network is impregnated with the aqueous liquid medium. In one embodiment, the storage modulus, G′, of the polymer gel exceeds the loss modulus, G″, of the polymer gel at any angular frequency within a range of from about 0.01 to about 100 radians/second, as determined by dynamic oscillatory measurements using a dynamic mechanical analysis instrument, such as, for example, a TA Instruments Q400 DMA.

In one embodiment, the polymer foam of the present invention and polymer foam component of the electronic device of the present invention each comprise the product obtained by contacting, typically in a liquid medium, based on 100 pbw of the polymer foam:
(i) from about 10 to about 40 pbw, more typically from about 15 to about 35 pbw, and even more typically from about 20 to about 35 pbw of the electrically conductive polymer, and
(ii) from about 60 to about 90 pbw, more typically from about 65 to about 85 pbw, and even more typically from about 65 to about 80 pbw of the at least one salt comprising a sulfonylimide anion.

In one embodiment of the polymer foam of the present invention and polymer foam component of the electronic device of the present invention, the ratio of the total amount by weight of the at least one salt comprising sulfonylimide anion in such foam to the total amount by weight of the electrically conductive polymer in such foam is typically from about 1.5:1 to about 45:1, more typically from 1.7:1 to 20:1, even more typically from about 1.7:1 to about 10:1, and still more typically from 2:1 to 8:1.

In one embodiment, the polymer foam of the present invention and polymer foam component of the electronic device of the present invention each comprise the product obtained by contacting, based on 100 pbw of the polymer foam:
(i) from about 10 to about 40 pbw, more typically from about 15 to about 35 pbw, and even more typically from about 20 to about 35 pbw of the electrically conductive polymer, and
(ii) from about 60 to about 90 pbw, more typically from about 65 to about 85 pbw, and even more typically from about 65 to about 80 pbw of the at least one salt comprising sulfonylimide anion, and
   the ratio of the total amount by weight of the at least one salt comprising a sulfonylimide anion in such foam to the total amount by weight of the electrically conductive polymer in such foam is typically from about 1.5:1 to about 45:1, more typically from 1.7:1 to 20:1, even more typically from about 1.7:1 to about 10:1, and still more typically from 2:1 to 8:1.

In one embodiment, the polymer foam of the present invention comprises a reaction product of the electrically conductive polymer and the at least one salt comprising a sulfonylimide anion. In one embodiment, the polymer foam has a porous structure, a high strength to weight and surface area to volume ratios, and high electrical conductivity. In one embodiment, the storage modulus, G′, of the polymer foam exceeds the loss modulus, G″, of the polymer foam at any angular frequency within a range of from about 0.01 to about 100 radians/second, as determined by dynamic oscillatory measurements using a dynamic mechanical analysis instrument, such as, for example, a TA Instruments Q400 DMA.

The polymer gels and polymer foams of the present invention may optionally further comprise gelling agents. Suitable gelling agents include compounds having at least two polar groups, such as pentaerythritol, or compounds that have at least two reactive functional groups, such as isocyanate compounds having at least two isocyanate groups, wherein an intermolecular bond, such as a hydrogen bond, is formed between the polar groups of the gelling agent or a covalent bond is formed between the reactive functional of the gelling agent to thereby form a three dimensional network that facilitates gelation of such composition. In one embodiment, the polymer gel of the present invention does not comprise a gelling agent. In one embodiment, the polymer foam of the present invention does not comprise a gelling agent.

The electrically conductive polymer component of the respective polymer composition, film, gel, foam, and/or polymer film, gel, foam component of the electronic device of the present invention may comprise one or more homopolymers, one or more co-polymers of two or more respective monomers, or a mixture of one or more homopolymers and one or more copolymers. The respective polymer composition, polymer film, and electrically conductive polymer film component of the electronic device of the present invention may each comprise a single polymer or may comprise a blend two or more polymers which differ from each other in some respect, for example, in respect to composition, structure, or molecular weight.

In one embodiment, the electrically conductive polymer of the composition, film, gel, foam, and/or electrically conductive polymer component of the electronic device of the present invention, comprises one or more electrically conductive polymers selected from electrically conductive polythiophene polymers, electrically conductive poly(selenophene) polymers, electrically conductive poly(telurophene) polymers, electrically conductive polypyrrole polymers, electrically conductive polyaniline polymers, electrically conductive fused polycylic heteroaromatic polymers, and blends of any such polymers.

In one embodiment, the electrically conductive polymer comprises one or more polymers selected from electrically conductive polythiophene polymers, electrically conductive poly(selenophene) polymers, electrically conductive poly(telurophene) polymers, and mixtures thereof. Suitable polythiophene polymers, poly(selenophene) polymers, poly(telurophene) polymers and methods for making such polymers are generally known. In one embodiment, the electrically conductive polymer comprises at least one electrically conductive polythiophene polymer, electrically conductive poly(selenophene) polymer, or electrically conductive poly(telurophene) polymer that comprises 2 or more, more typically 4 or more, monomeric units according to structure (I) per molecule of the polymer:

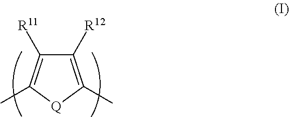

wherein:

Q is S, SE, or Te, and

each occurrence of R¹¹ and each occurrence of R¹² is independently H, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, hydroxyl, hydroxyalkyl, benzyl, carboxylate, ether, ether carboxylate, amidosulfonate, ether sulfonate, ester sulfonate, and urethane, or both the R¹ group and R² group of a given monomeric unit are fused to form, together with the carbon atoms to which they are attached, an alkylene or alkenylene chain completing a 3, 4, 5, 6, or 7-membered aromatic or alicyclic ring, which ring may optionally include one or more divalent nitrogen, selenium, tellurium, sulfur, or oxygen atoms.

In one embodiment, Q is S, the R¹¹ and R¹² of the monomeric unit according to structure (I) are fused and the electrically conductive polymer comprises a polydioxythiopene polymer that comprises 2 or more, more typically 4 or more, monomeric units according to structure (I.a) per molecule of the polymer:

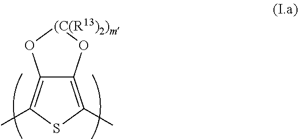

wherein:

each occurrence of R¹³ is independently H, alkyl, hydroxyl, heteroalkyl, alkenyl, heteroalkenyl, hydroxalkyl, amidosulfonate, benzyl, carboxylate, ether, ether carboxylate, ether sulfonate, ester sulfonate, or urethane, and

m′ is 2 or 3.

In one embodiment, all R¹³ groups of the monomeric unit according to structure (I.a) are each H, alkyl, or alkenyl. In one embodiment, R¹³ groups of the monomeric unit according to structure (I.a) is not H. In one embodiment, each R¹³ groups of the monomeric unit according to structure (I.a) is H.

In one embodiment, the electrically conductive polymer comprises an electrically conductive polythiophene homopolymer of monomeric units according to structure (I.a) wherein each R¹³ is H and m′ is 2, known as poly(3,4-ethylenedioxythiophene), more typically referred to as “PEDOT”.

In one embodiment, the electrically conductive polymer comprises one or more electrically conductive polypyrrole polymers. Suitable electrically conductive polypyrrole polymers and methods for making such polymers are generally known. In one embodiment, the electrically conductive polymer comprises a polypyrrole polymer that comprises 2 or more, more typically 4 or more, monomeric units according to structure (II) per molecule of the polymer:

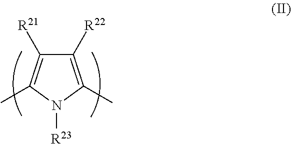

wherein:

each occurrence of R²¹ and each occurrence of R²² is independently H, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, hydroxyl, hydroxyalkyl, benzyl, carboxylate, ether, amidosulfonate, ether carboxylate, ether sulfonate, ester sulfonate, and urethane, or the R²¹ and R²² of a given pyrrole unit are fused to form, together with the carbon atoms to which they are attached, an alkylene or alkenylene chain completing a 3, 4, 5, 6, or 7-membered aromatic or alicyclic ring, which ring may optionally include one or more divalent nitrogen, sulfur or oxygen atoms, and

each occurrence of R²³ is independently selected so as to be the same or different at each occurrence and is selected from hydrogen, alkyl, alkenyl, aryl, alkanoyl, alkylthioalkyl, alkylaryl, arylalkyl, amino, epoxy, silane, siloxane, hydroxyl, hydroxyalkyl, benzyl, carboxylate, ether, ether carboxylate, ether sulfonate, ester sulfonate, and urethane

In one embodiment, each occurrence of R²¹ and each occurrence of R²² is independently H, alkyl, alkenyl, alkoxy, cycloalkyl, cycloalkenyl, hydroxyl, hydroxyalkyl, benzyl, carboxylate, ether, amidosulfonate, ether carboxylate, ether sulfonate, ester sulfonate, urethane, epoxy, silane, siloxane, or alkyl, wherein the alky group may optionally be substituted with one or more of sulfonic acid, carboxylic acid, acrylic acid, phosphoric acid, phosphonic acid, halogen, nitro, cyano, hydroxyl, epoxy, silane, or siloxane moieties.

In one embodiment, each occurrence of R²³ is independently H, alkyl, and alkyl substituted with one or more of sulfonic acid, carboxylic acid, acrylic acid, phosphoric acid, phosphonic acid, halogen, cyano, hydroxyl, epoxy, silane, or siloxane moieties.

In one embodiment, each occurrence of R²¹, R²², and R²³ is H.

In one embodiment, R²¹ and R²² are fused to form, together with the carbon atoms to which they are attached, a 6- or 7-membered alicyclic ring, which is further substituted with a group selected from alkyl, heteroalkyl, hydroxyl, hydroxyalkyl, benzyl, carboxylate, ether, ether carboxylate, ether sulfonate, ester sulfonate, and urethane. In one embodiment, and R²² are fused to form, together with the carbon atoms to which they are attached, a 6- or 7-membered alicyclic ring, which is further substituted with an alkyl group. In one embodiment, R²¹ and R²² are fused to form, together with the carbon atoms to which they are attached, a 6- or 7-membered alicyclic ring, which is further substituted with an alkyl group having at least 1 carbon atom.

In one embodiment, R²¹ and R²² are fused to form, together with the carbon atoms to which they are attached, a —O—(CHR²⁴)n′-O— group, wherein:

each occurrence of R²⁴ is independently H, alkyl, hydroxyl, hydroxyalkyl, benzyl, carboxylate, amidosulfonate, ether, ether carboxylate, ether sulfonate, ester sulfonate, and urethane, and

n′ is 2 or 3.

In one embodiment, at least one R²⁴ group is not hydrogen. In one embodiment, at least one R²⁴ group is a substituent having F substituted for at least one hydrogen. In one embodiment, at least one Y group is perfluorinated.

In one embodiment, the electrically conductive polymer comprises one or more electrically conductive polyaniline polymers. Suitable electrically conductive polyaniline polymers and methods of making such polymers are generally known. In one embodiment, the electrically conductive polymer comprises a polyaniline polymer that comprises 2 or more, more typically 4 or more, monomeric units selected from monomeric units according to structure (III) and monomeric units according to structure (III.a) per molecule of the polymer:

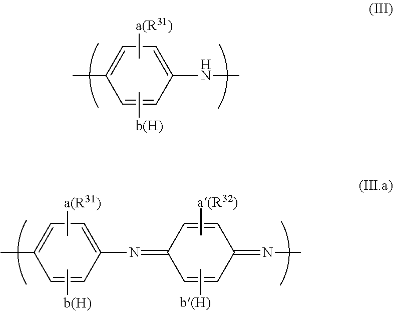

wherein:

each occurrence of R³¹ and R³² s independently alkyl, alkenyl, alkoxy, cycloalkyl, cycloalkenyl, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen, cyano, or alkyl substituted with one or more of sulfonic acid, carboxylic acid, halo, nitro, cyano or epoxy moieties, or two R³¹ or R³² groups on the same ring may be fused to form, together with the carbon atoms to which they are attached, a 3, 4, 5, 6, or 7-membered aromatic or alicyclic ring, which ring may optionally include one or more divalent nitrogen, sulfur or oxygen atoms. and

each a and a′ is independently an integer from 0 to 4,

each b and b′ is integer of from 1 to 4, wherein, for each ring, the sum of the a and b coefficients of the ring or the a′ and b′ coefficients of the ring is 4.

In one embodiment, a or a′=0 and the polyaniline polymer is an non-substituted polyaniline polymers referred to herein as a “PANI” polymer.

In one embodiment, the electrically conductive polymer comprises one or more electrically conductive polycylic heteroaromatic polymers. Suitable electrically conductive polycylic heteroaromatic polymers and methods for making such polymers are generally known. In one embodiment, the electrically conductive polymer comprises one or more polycylic heteroaromatic polymers that comprise 2 or more, more typically 4 or more, monomeric units per molecule that are derived from one or more heteroaromatic monomers, each of which is independently according to Formula (IV):

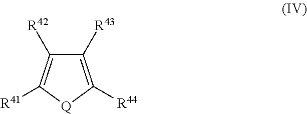

wherein:

Q is S or NH,

R⁴¹, R⁴², R⁴³, and R⁴⁴ are each independently H, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, hydroxyl, hydroxyalkyl, benzyl, carboxylate, ether, ether carboxylate, amidosulfonate, ether sulfonate, ester sulfonate, or urethane, provided that at least one pair of adjacent substituents R⁴¹ and R⁴², R⁴² and R⁴³, or R⁴³ and R⁴⁴ are fused to form, together with the carbon atoms to which they are attached, a 5 or 6-membered aromatic ring, which ring may optionally include one or more hetero atoms, more typically selected from divalent nitrogen, sulfur and oxygen atoms, as ring members.

In one embodiment, the polycylic heteroaromatic polymers comprise 2 or more, more typically 4 or more, monomeric units per molecule that are derived from one or more heteroaromatic monomers, each of which is independently according to structure (V):

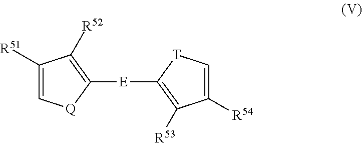

wherein:

Q is S, Se, Te, or NR⁵⁵,

T is S, Se, Te, NR⁵⁵, O, Si(R⁵⁵)₂, or PR⁵⁵,

E is alkenylene, arylene, and heteroarylene,

R⁵⁵ is hydrogen or alkyl,

R⁵¹, R⁵², R⁵³, and R⁵⁴ are each independently H, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, nitrile, cyano, hydroxyl, epoxy, silane, siloxane, hydroxyl, hydroxyalkyl, benzyl, carboxylate, ether, ether carboxylate, amidosulfonate, ether sulfonate, and urethane, or where each pair of adjacent substituents R⁵¹ and R⁵² and adjacent substituents R⁵³ and R⁵⁴ may independently form, together with the carbon atoms to which they are attached, a 3, 4, 5, 6, or 7-membered aromatic or alicyclic ring, which ring may optionally include one or more hetero atoms, more typically selected from divalent nitrogen, sulfur and oxygen atoms, as ring members.

In one embodiment, the electrically conductive polymer comprises an electrically conductive copolymer that comprises at least one first monomeric unit per molecule that is according to formula (I), (I.a), (II), (III), or (III.a) or that is derived from a heteroaromatic monomer according to structure (IV) or (V) and further comprises one or more second monomeric units per molecule that differ in structure and/or composition from the first monomeric units. Any type of second monomeric units can be used, so long as it does not detrimentally affect the desired properties of the copolymer. In one embodiment, the copolymer comprises, based on the total number of monomer units of the copolymer, less than or equal to 50%, more typically less than or equal to 25%, even more typically less than or equal to 10% of second monomeric units.

Exemplary types of second monomeric units include, but are not limited to those derived from alkenyl, alkynyl, arylene, and heteroarylene monomers, such as, for example, fluorene, oxadiazole, thiadiazole, benzothiadiazole, phenylene vinylene, phenylene ethynylene, pyridine, diazines, and triazines, all of which may be further substituted, that are copolymerizable with the monomers from which the first monomeric units are derived.

In one embodiment, the electrically conductive copolymers are made by first forming an intermediate oligomer having the structure A-B-C, where A and C represent first monomeric units, which can be the same or different, and B represents a second monomeric unit. The A-B-C intermediate oligomer can be prepared using standard synthetic organic techniques, such as Yamamoto, Stille, Grignard metathesis, Suzuki and Negishi couplings. The electrically conductive copolymer is then formed by oxidative polymerization of the intermediate oligomer alone, or by copolymerization of the intermediate oligomer with one or more additional monomers.

In one embodiment, the electrically conductive polymer comprises an electrically conductive copolymer of two or more monomers. In one embodiment, the monomers comprise at least one monomer selected from a thiophene monomer, a pyrrole monomer, an aniline monomer, and a polycyclic aromatic monomer.

In one embodiment, the weight average molecular weight of the electrically conductive polymer is from about 1000 to about 2,000,000 grams per mole, more typically from about 5,000 to about 1,000,000 grams per mole, and even more typically from about 10,000 to about 500,000 grams per mole.

In one embodiment, the electrically conductive polymer of the respective polymer composition, polymer film, and electronic device of the present invention further comprises a polymeric acid dopant, typically (particularly where the liquid medium of the polymer composition is an aqueous medium), a water soluble polymeric acid dopant. In one embodiment, the electrically conductive polymers used in the new compositions and methods are prepared by oxidatively polymerizing the corresponding monomers in aqueous solution containing a water soluble acid, typically a water-soluble polymeric acid. In one embodiment, the acid is a polymeric sulfonic acid. Some non-limiting examples of the acids are poly(styrenesulfonic acid) (“PSSA”), poly(2-acrylamido-2-methyl-1-propanesulfonic acid) (“PAAMPSA”), and mixtures thereof. The acid anion provides the dopant for the conductive polymer. The oxidative polymerization is carried out using an oxidizing agent such as ammonium persulfate, sodium persulfate, and mixtures thereof. Thus, for example, when aniline is oxidatively polymerized in the presence of PMMPSA, the doped electrically conductive polymer blend PANI/PAAMPSA is formed. When ethylenedioxythiophene (EDT) is oxidatively polymerized in the presence of PSSA, the doped electrically conductive polymer blend PEDT/PSS is formed. The conjugated backbone of PEDT is partially oxidized and positively charged. Oxidatively polymerized pyrroles and thienothiophenes also have a positive charge which is balanced by the acid anion.

In one embodiment, the water soluble polymeric acid selected from the polysulphonic acids, more typically, poly(styrene sulfonic acid), or poly(acrylamido-2-methyl-1-propane-sulfonic acid), or a polycarboxylic acid, such as polyacrylic acid polymethacrylic acid, or polymaleic acid.

In one embodiment, the electrically conductive polymer component of the respective polymer film, polymer solution or dispersion, and/or electronic device of the present invention, comprises, based on 100 pbw of the electrically conductive polymer:
(i) from greater than 0 pbw to 100 pbw, more typically from about 10 to about 50 pbw, and even more typically from about 20 to about 50 pbw, of at least one electrically conductive polymer, more typically of at least one electrically conductive polymer comprising monomeric units according to structure (I.a), more typically at least one polythiophene polymer comprising monomeric units according to structure (I.a), wherein Q is S, and even more typically of at least one electrically conductive polymer comprising poly(3,4-ethylenedioxythiophene), and
(ii) from 0 pbw to 100 pbw, more typically from about 50 to about 90 pbw, and even more typically from about 50 to about 80 pbw, of at least one water soluble polymeric acid dopant, more typically of at least one water soluble polymeric acid dopant comprising a poly(styrene sulfonic acid) dopant.

In one embodiment, wherein when the electrically conductive polymer component of the respective polymer film, polymer gel, polymer foam, polymer composition, and/or electronic device described herein is a blend of a poly(thiophene) polymer and a water soluble acid polymer, the at least one salt comprising a sulfonylimide anion of such polymer film, polymer gel, polymer film, polymer composition, and/or electronic device does not comprise iodidated 1-hexyl-3-methylimidazolium or 1-ethyl-3-methylimidazolium bis(trifluoromethanesulfonyl)imide.

In one embodiment, the polymer composition of the present invention comprises, based on 100 pbw of the polymer composition:
(i) from greater than 0 to less than 100 pbw, more typically from about 50 to less than 100 pbw, even more typically from about 90 to about 99.5 pbw of a liquid carrier, comprising, based on 100 pbw of the liquid medium, from about 5 to less than 95 pbw, more typically from about 20 pbw to 80 pbw, and even more typically, from about 30 to 70 pbw, water, about 5 pbw to about 95 pbw, more typically from 20 pbw to about 80 pbw, and even more typically from 30 pbw to about 70 pbw of the at least one water miscible polar organic liquid,
(ii) from greater than 0 to less than 100 pbw, more typically from greater than 0 to about 50 pbw, even more typically from about 0.1 pbw to about 10 pbw of a combined amount of the at least one electrically conductive polymer and the at least one salt comprising a sulfonylimide anion, comprising, based on the combined amount of the electrically conductive polymer and the at least one salt comprising a sulfonylimide anion:
   (a) from about 1 to about 99.9 pbw, more typically from about 10 to about 90 pbw, and even more typically from about 10 to about 80 pbw of the electrically conductive polymer, more typically of an electrically conductive polymer comprising, based on 100 pbw of the electrically conductive polymer:
      (1) from greater than 0 pbw to 100 pbw, more typically from about 10 to about 50 pbw, and even more typically from about 20 to about 50 pbw of at least one polythiophene polymer comprising monomeric units according to structure (I.a) wherein Q is S, and more typically, at least one polythiophene polymer comprising poly(3,4-ethylenedioxythiophene), and
      (2) from 0 pbw to 100 pbw, more typically from about 50 to about 90 pbw, and even more typically from about 50 to about 80 pbw, of at least one water soluble polymeric acid dopant, more typically of at least one water soluble polymeric acid dopant comprising a poly(styrene sulfonic acid) dopant, and
   (b) from about 0.1 pbw to about 99 pbw, more typically from about 10 pbw to about 90 pbw, and even more typically from about 20 pbw to about 90 pbw, of at least one salt comprising a sulfonylimide anion, wherein the ratio of the total amount by weight of the at least one salt comprising a sulfonylimide anion in such composition to the total amount by weight of the electrically conductive polymer in such composition is typically from greater than 0:1 to about 20:1, more typically from about 0.1:1 to 10:1.

In one embodiment, the respective polymer film of the present invention and polymer film component of the electronic device of the present invention comprises, based on 100 parts by weight of the polymer film:
(a) from about 1 to about 99.9 pbw, more typically from about 10 to about 90 pbw, more typically 10 to about 80 pbw, of the at least one electrically conductive polymer, more typically of an electrically conductive polymer comprising, based on 100 pbw of the electrically conductive polymer:
   (1) from greater than 0 pbw to 100 pbw, more typically from about 10 to about 50 pbw, and even more typically from about 20 to about 50 pbw of at least one polythiophene polymer comprising monomeric units according to structure (I.a) wherein Q is S, and more typically, at least one polythiophene polymer comprising poly(3,4-ethylenedioxythiophene), and
   (2) from 0 pbw to 100 pbw, more typically from about 50 to about 90 pbw, and even more typically from about 50 to about 80 pbw, of at least one water soluble polymeric acid dopant, more typically of at least one water soluble polymeric acid dopant comprising a poly(styrene sulfonic acid) dopant, and
(b) from about 0.1 pbw to about 99 pbw, more typically from about 10 pbw to about 90 pbw, and even more typically from about 20 pbw to about 90 pbw, of at least one lithium salt, even more typically at least one salt comprising a sulfonylimide anion, wherein the ratio of the total amount by weight of the at least one salt comprising a sulfonylimide anion in such film to the total amount by weight of the electrically conductive polymer in such film is typically from greater than 0:1 to about 20:1, more typically from about 0.1:1 to 10:1.

In one embodiment, the respective polymer film the present invention and polymer film component of the electronic device of the present invention comprises, based on 100 pbw of the polymer film:
(a) from about 5 to about 99.9 pbw, more typically from about 10 to about 90 pbw, and even more typically from about 10 to about 80 pbw of at least one electrically conductive polymer, comprising, based on 100 pbw of the electrically conductive polymer:
   (1) from about 20 to about 50 pbw of poly(3,4-ethylenedioxythiophene), and
   (2) from about 50 to about 80 pbw of poly(styrene sulfonic acid) dopant, and
   (b) from about 0.1 to 99 pbw, more typically from about 10 to 90 pbw, even more typically from about 20 to 90 pbw of at least one salt comprising a sulfonylimide anion, wherein the ratio of the total amount by weight of the at least one salt comprising a sulfonylimide anion in such film to the total amount by weight of the electrically conductive polymer in such film is typically from greater than 0:1 to about 20:1, more typically from about 0.1:1 to 10:1.

In some embodiments, the polymer composition, polymer film, polymer gel, polymer foam, or polymer film, gel, or foam component of the electronic device of the present invention may optionally further comprise an ionic liquid.

Typically, ionic liquids are organic salts that consist entirely of anionic and cationic species and have a melting point of less than or equal to 100° C. In one embodiment, the ionic liquid has a melting point of less than or equal to 75° C., more typically less than or equal to 50° C. and even more typically less than or equal to 25° C.

In one embodiment, the ionic liquid comprises one or more organic salts that consist entirely of anionic and cationic species and have a melting point of less than or equal to 100° C.

In one embodiment, the cation of an ionic liquid compound is a bulky, asymmetrical organic moiety. Typical cations for suitable ionic liquid compounds include, for example:

cations of formula VI′ such as, for example, ammonium, tetramethyl ammonium, triethyl ammonium, trimethyltetradecyl ammonium, tetrabutyl ammonium, tetrahexyl ammonium, butyltrimethyl ammonium, methyltrioctyl ammonium, tetrakis(decyl)ammonium, tetraoctyl ammonium, tributylmethyl ammonium, bis(2-hydroxyethyl)methyl ammonium, (2-hydroxyethyl)dimethyloctyl ammonium, tris(2-hydroxyethyl)methyl ammonium, (2-hydroxyethyl)trimethyl ammonium, (2-acetoxyethyl)trimethyl ammonium, tetraheptyl ammonium, tetradodecyl ammonium, tetraethyl ammonium, ethyldimethylpropyl ammonium, benzyltrimethyl ammonium, benzyldimethyltetradecyl ammonium, benzyltributyl ammonium tris(2-(2-methoxyethoxy)ethyl) ammonium, dimethyldioctadecyl ammonium, 1-carboxy-N,N,N-trimethylmethanaminium, phenyldimethyl ammonium, diisopropylethyl ammonium, bis(trifluoromethylsulfonyl)phenyl ammonium, (trifluoromethylsulfonyl)phenyl ammonium, bis(trifluoromethylsulfonyl)propyl ammonium, bis(trifluoromethylsulfonyl)butyl ammonium, bis(trifluoromethylsulfonyl)ethyl ammonium, bis(trifluoromethylsulfonyl)(trimethylsilyl) ammonium, bis(trifluoromethylsulfonyl)-tris(trimethyl)silyl ammonium, bis(trifluoromethylsulfonyl)-(tert-butyl)dimethylsilyl ammonium, allylsulfonyltrimethylsulfonyl ammonium, and vinylsulfonyltrimethylsulfonyl ammonium cations,

pyrazolium cations, such as, for example, 1-butyl-2,3,5-trimethylpyrazolium, 1,2,4-trimethylpyrazolium, and 1-butyl-2-methylpyrazolium cations,

pyrrolinium cations,

thiazolium cations,

oxazolium cations,

cations of formula VII such as, for example, N,N-dimethyl-morpholinium, N,N-diethyl-morpholinium, N-ethoxymethyl-N-methyl-morpholinium cations,

cations of formula VIII, such as, for example, 1-butyl-1-methyl-piperidinium, 1-methyl-1-propyl-piperidinium, 1,1-dimethyl-piperidinium, 1-ethoxyethyl-1-methyl-piperidinium, 1-hexyl-1-methyl-piperidinium, and 1-methyl-1-octyl-piperidinium cations,

cations of formula IX such as, for example, 1-butyl-1-methyl-pyrrolidinium, 1-ethyl-1-methyl-pyrrolidinium, 1-methyl-1-propyl-pyrrolidinium, 1,1-dimethyl-pyrrolidinium, 1-ethoxyethyl-1-methyl-pyrrolidinium, 1-hexyl-1-methyl-pyrrolidinium, and 1-methyl-1-octyl-pyrrolidinium cations,

cations of formula X such as, for example, 1,3-dimethyl-imidazolium, 1-benzyl-3-methyl-imidazolium, 1-butyl-3-methyl-imidazolium, 1-ethyl-3-methyl-imidazolium, 1-hexyl-3-methyl-imidazolium, 1-methyl-3-propyl-imidazolium, 1-methyl-3-octyl-imidazolium, 1-methyl-3-tetradecyl-imidazolium, 1-methyl-3-phenyl-imidazolium, 1,2,3-trimethyl-imidazolium, 1,2-methyl-3-octyl-imidazolium, 1-butyl-2,3-dimethyl-imidazolium, 1-hexyl-2,3-methyl-imidazolium, 1-(2-hydroxyethyl)-2,3-dimethyl-imidazolium, 1-pentyl-3-methyl-imidazolium, 1-isobutyl-3-methyl-imidazolium, 3-methyl-1-pentyl-imidazolium, and 1-heptyl-3-methyl-imidazolium cations,

pyridazinium cations;

pyrazinium cations;

cations of formula XI such as, for example, N-butyl-pyridinium, N-hexyl-pyridinium cations, N-butyl-4-methyl-pyridinium, N-butyl-3-methyl-pyridinium, and N-(3-hydroxypropyl)pyridinium cations,

triazolium cations,

pyrrolium cations, such as, for example, 1,1-dimethyl-pyrrolium, 1-methyl-1-pentyl-pyrrolium cations,

cations of formula XI′ such as, for example, tributyloctyl phosphonium, tributyldodecyl phosphonium, tetrabutyl phosphonium, tributylmethyl phosphonium, triethylmethyl phosphonium, and trihexyl(tetradecyl)phosphonium cations,

cations of formula XII such as, for example, guanidinium, tetramethylguanidinium, hexamethylguanidium, N,N,N′,N′-tetrahexyl-N″,N″-dimethylguanidinium, 2-amino-1,3-dimethyl-4,5-dihydro-1H-imidazol-3-ium, 2-((2-methoxyethyl)(methyl)amino)-1,3-dimethyl-4,5-dihydro-1H-imidazol-3-ium, 2-(ethyl(2-methoxyethyl)amino)-1,3-dimethyl-4,5-dihydro-1H-imidazol-3-ium, N-((dimethylamino)((2-methoxyethyl)(methyl)amino)methylene)-N-methylmethanaminium, 2-(ethyl(methyl)amino)-1,3-dimethyl-4,5-dihydro-1H-imidazol-3-ium, and 1,3-dimethyl-2-(methyl(propyl)amino)-4,5-dihydro-1H-imidazol-3-ium cations,

cations of formula XIII such as, for example, 1,2,3-tris(diethylamino)-cyclopropenylium and 1,2,3-tris(dimethylamino)-cyclopropenylium cations,

cations of formula XIII′, such as, for example, triethylsulfonium, cyclopropyldiphenyl sulfonium, and trimethyl sulfonium cations,

cations of formula XXIII, such as, for example, diphenyliodonium, (4-isopropylphenyl)(p-tolyl)iodonium, and bis(4-(tert-butyl)phenyl)iodonium cations, and

triazine ammonium cations, such as, for example, 1,3,5-triazin-2,4,6-triaminium, 6-amino-1,3,5-triazin-2,4-diaminium, and 4,6-diamino-1,3,5-triazin-2-aminium cations.

Typical anions for suitable ionic liquid compounds include, for example

Halogenoaluminate(III) anions, such as, for example, tetrachloroaluminate,

chlorate anions,

cyanate anions, such as thiocyanate, cyanate, and isocyanate anions,

halide anions, such as fluoride, chloride, bromide, and iodide anions,

nitrate anions,

dicyanamide anions;

fluorohydrogenate anions, such as, for example, poly(hydrogen fluoride) fluoride anions,

fluorometallate anions, such as, for example, oxopentafluorotungstan (VI) anions,

anions of formula XV such as, for example, tetrafluoroborate, tetracyanoborate, tetrakis-(p-(dimethyl(1H, 1H, 2H, 2H-perfluorooctyl)silyl)phenyl)borate, alkyltrifluoroborate, perfluoroalkyltrifluoroborate, and alkenyltrifluoroborate anions,

anions of formula XVI such as, for example, carbonate, hydrogen carbonate, methylcarbonate, salicylate, thiosalicylate, lactate, acetate, trifluoroacetate, and formate anions,

anions of formula XVII such as, for example, tricyanomethanide, tris[2,2,2-trifluoroethoxy(sulfonyl)]methanide, and tris[trifluoromethyl(sulfonyl)]methanide,

anions of formula XIX such as, for example, phosphate (PO₄³⁻), monohydrogen phosphate (HPO₄²⁻), dihydrogen phosphate (H₂PO₄⁻), diethyl phosphate and dibenzyl phosphate,

anions of formula XX such as, for example, hexafluorophosphate, di(trifluoromethyl)tetrafluorophosphate, tris(trifluoromethyl)trifluorophosphate, tris(perfluoroalkyl)trifluorophosphate, such as tris(perfluoroethyl)trifluorophosphate, tetra(trifluoromethyl)difluorophosphate, penta(trifluoromethyl)fluorphosphate, and hexa(trifluoromethylphosphate anions,

anions of formula XXI such as, for example, sulfate (SO₄²), hydrogen sulfate (HSO₄⁻), and (C₁-C₁₂)alkylsulfates, such as methylsulfate and octylsulfate, (C₁-C₁₂)alkylsulfonate anions, such trifluoromethanesulfonate, perfluoroethylsulfonate and methanesulfonate, and arylsulfonate anions, such as tosylate, and

anions of formula XXII such as, for example, perfluoroalkyl β-diketonate anions, such as, for example, 6,6,7,7,8,8,8-heptafluoro-2,2-dimethyl-3,5-octanedionate, 1,1,1,5,5,5-hexafluoro-2,4-pentanedionate, and 4,4,4-trifluoro-1-(2-thienyl)-1,3-butanedionate anions.

The ionic liquid may comprise a mixture of ionic liquid compounds and thus a mixture of two or more of such cations and/or two or more of such anions.

The cation and anion of the ionic liquid are selected, according to techniques known in the art, to tailor the properties of the ionic liquid to suit the demands of the particular application, for example an ionic liquid with an imidazolium cation would typically be expected to provide lower viscosity and higher conductivity, but lower stability, than an analogous ionic liquid with ammonium or pyrrolidium cation, and an ionic liquid with a smaller anion, such as dicyanamide and tetracyanoborate anions, would typically be expected to provide higher conductivity, but lower stability, than an analogous ionic liquid with a larger anion, such as a tris(pentafluoroethyl)trifluorophosphate anion.

In one embodiment, the ionic liquid is an ionic compound that has a melting point of less than or equal to 25° C., such as, for example, 1-ethyl-3-methyl-imidazolium tetrachloroaluminate, 1-butyl-3-methyl-imidazolium tetrachloroaluminate, 1-ethyl-3-methyl-imidazolium acetate, 1-butyl-3-methyl-imidazolium acetate, 1-ethyl-3-methyl-imidazolium ethylsulfate, 1-butyl-3-methyl-imidazolium methylsulfate, 1-ethyl-3-methyl-imidazolium thiocyanate, 1-butyl-3-methyl-imidazolium thiocyanate, 1-ethyl-3-methyl-imidazolium tetracyanoborate, 1-butyl-1-methyl-pyrrolidinium dicyanamide, 1-ethyl-3-methyl-imidazolium tetrafluoroborate, 1-ethyl-3-methyl-imidazolium trifluoroacetate, and mixtures thereof.

In one embodiment, the ionic liquid is an ionic compound that has a melting point of less than 25° C., a viscosity at 20° C. of less than or equal to about 100 centiPoise, and a specific conductance of greater than or equal to about 5 milliSiemens per centimeter (“mS/cm”), more typically greater than 10 mS/cm, such as, for example, 1-ethyl-3-methyl-imidazolium tetracyanoborate, 1-butyl-1-methyl-pyrrolidinium dicyanamide, 1-ethyl-3-methyl-imidazolium tetrafluoroborate, 1-ethyl-3-methyl-imidazolium thiocyanate, 1-ethyl-3-methyl-imidazolium trifluoroacetate, and mixtures thereof.

In one embodiment, the ionic liquid comprises a salt of an alkyl-, hydroxyalkyl- and/or aryl-substituted imidazolium cation and a cyanate anion, such as, for example, 1,3-dimethyl-imidazolium dicyanate, 1-benzyl-3-methyl-imidazolium thiocyanate, 1-butyl-3-methyl-imidazolium tricyanomethanide, 1-ethyl-3-methyl-imidazolium dicyanate, 1-hexyl-3-methyl-imidazolium thiocyanate, 1-methyl-3-propyl-imidazolium tricyanomethanide, 1-methyl-3-octyl-imidazolium dicyanate, 1-methyl-3-tetradecyl-imidazolium thiocyanate, 1-methyl-3-phenyl-imidazolium dicyanate, 1,2,3-trimethyl-imidazolium thiocyanate, 1,2-methyl-3-octyl-imidazolium tricyanomethanide, 1-butyl-2,3-dimethyl-imidazolium dicyanate, 1-hexyl-2,3-methyl-imidazolium thiocyanate, and 1-(2-hydroxyethyl)-2,3-dimethyl-imidazolium tricyanomethanide, and mixtures thereof.

In one embodiment, the ionic liquid comprises a salt of an alkyl-, hydroxyalkyl- and/or aryl-substituted imidazolium cation and a tetracyanoborate anion, such as, for example, 1,3-dimethyl-imidazolium tetracyanoborate, 1-benzyl-3-methyl-imidazolium tetracyanoborate, 1-butyl-3-methyl-imidazolium tetracyanoborate, 1-ethyl-3-methyl-imidazolium tetracyanoborate, 1-hexyl-3-methyl-imidazolium tetracyanoborate, 1-methyl-3-propyl-imidazolium tetracyanoborate, 1-methyl-3-octyl-imidazolium tetracyanoborate, 1-methyl-3-tetradecyl-imidazolium tetracyanoborate, 1-methyl-3-phenyl-imidazolium tetracyanoborate, 1,2,3-trimethyl-imidazolium tetracyanoborate, 1,2-methyl-3-octyl-imidazolium tetracyanoborate, 1-butyl-2,3-dimethyl-imidazolium tetracyanoborate, 1-hexyl-2,3-methyl-imidazolium tetracyanoborate, and 1-(2-hydroxyethyl)-2,3-dimethyl-imidazolium tetracyanoborate, and mixtures thereof.

In one embodiment, the ionic liquid comprises a salt of an alkyl-, hydroxyalkyl- and/or aryl-substituted imidazolium cation and a tetrakis-(p-(dimethyl(1H, 1H, 2H, 2H-perfluorooctyl)silyl)phenyl)borate anion, such as, for example, 1,3-dimethyl-imidazolium tetrakis-(p-(dimethyl(1H, 1H, 2H, 2H-perfluorooctyl)silyl)phenyl)borate, 1-benzyl-3-methyl-imidazolium tetrakis-(p-(dimethyl(1H, 1H, 2H, 2H-perfluorooctyl)silyl)phenyl)borate, 1-butyl-3-methyl-imidazolium tetrakis-(p-(dimethyl(1H, 1H, 2H, 2H-perfluorooctyl)silyl)phenyl)borate, 1-ethyl-3-methyl-imidazolium tetrakis-(p-(dimethyl(1H, 1H, 2H, 2H-perfluorooctyl)silyl)phenyl)borate, 1-hexyl-3-methyl-imidazolium tetrakis-(p-(dimethyl(1H, 1H, 2H, 2H-perfluorooctyl)silyl)phenyl)borate, 1-methyl-3-propyl-imidazolium tetrakis-(p-(dimethyl(1H, 1H, 2H, 2H-perfluorooctyl)silyl)phenyl)borate, 1-methyl-3-octyl-imidazolium tetrakis-(p-(dimethyl(1H, 1H, 2H, 2H-perfluorooctyl)silyl)phenyl)borate, 1-methyl-3-tetradecyl-imidazolium tetrakis-(p-(dimethyl(1H, 1H, 2H, 2H-perfluorooctyl)silyl)phenyl)borate, 1-methyl-3-phenyl-imidazolium tetrakis-(p-(dimethyl(1H, 1H, 2H, 2H-perfluorooctyl)silyl)phenyl)borate, 1,2,3-trimethyl-imidazolium tetrakis-(p-(dimethyl(1H, 1H, 2H, 2H-perfluorooctyl)silyl)phenyl)borate, 1,2-methyl-3-octyl-imidazolium tetrakis-(p-(dimethyl(1H, 1H, 2H, 2H-perfluorooctyl)silyl)phenyl)borate, 1-butyl-2,3-dimethyl-imidazolium tetrakis-(p-(dimethyl(1H, 1H, 2H, 2H-perfluorooctyl)silyl)phenyl)borate, 1-hexyl-2,3-methyl-imidazolium tetrakis-(p-(dimethyl(1H, 1H, 2H, 2H-perfluorooctyl)silyl)phenyl)borate, and 1-(2-hydroxyethyl)-2,3-dimethyl-imidazolium tetrakis-(p-(dimethyl(1H, 1H, 2H, 2H-perfluorooctyl)silyl)phenyl)borate, and mixtures thereof.

In one embodiment, the ionic liquid comprises a salt of an alkyl-, hydroxyalkyl- and/or aryl-substituted imidazolium cation and a hexafluorophosphate anion, such as, for example, 1,3-dimethyl-imidazolium hexafluorophosphate, 1-benzyl-3-methyl-imidazolium hexafluorophosphate, 1-butyl-3-methyl-imidazolium hexafluorophosphate, 1-ethyl-3-methyl-imidazolium hexafluorophosphate, 1-hexyl-3-methyl-imidazolium hexafluorophosphate, 1-methyl-3-propyl-imidazolium hexafluorophosphate, 1-methyl-3-octyl-imidazolium hexafluorophosphate, 1-methyl-3-tetradecyl-imidazolium hexafluorophosphate, 1-methyl-3-phenyl-imidazolium hexafluorophosphate, 1,2,3-trimethyl-imidazolium hexafluorophosphate, 1,2-methyl-3-octyl-imidazolium hexafluorophosphate, 1-butyl-2,3-dimethyl-imidazolium hexafluorophosphate, 1-hexyl-2,3-methyl-imidazolium hexafluorophosphate, and 1-(2-hydroxyethyl)-2,3-dimethyl-imidazolium hexafluorophosphate, and mixtures thereof.

In one embodiment, wherein the electrically conductive polymer component of the respective polymer film, gel, foam, composition, and/or electronic device of the present invention comprises a blend of a poly(thiophene) polymer and a water soluble acid polymer, or more typically of poly(3,4-ethylenedioxythiophene) and poly(styrene sulfonic acid), the ionic liquid component of such polymer film, gel, foam, composition, and/or electronic device does not comprise 1-butyl-3-methyl-imidazolium tetrafluoroborate, or, more typically the ionic liquid component of such polymer film, gel, foam, composition, and/or electronic device does not comprise a tetrafluoroborate anion.

In one embodiment, the ionic liquid component of the respective polymer film, gel, foam, composition, and/or electronic device of the present invention does not comprise a tetrafluoroborate anion.

In one embodiment, wherein the electrically conductive polymer component of the respective polymer film, gel, foam, composition, and/or electronic device described herein is a blend of a poly(thiophene) polymer and a water soluble acid polymer, the ionic liquid component of such polymer film, gel, foam, composition, and/or electronic device typically does not comprise a para-toluene sulfonate anion, tetrafluoroborate anion, (CF₃SO₃)⁻ anion, (CH₃CH₂CH₂CH₂SO₃)⁻ anion, or (CHF₂CF₂CF₂CF₂CH₂SO₃)⁻ anion, and, even more typically, does not comprise a sulfonate anion, sulfate anion, carboxylate anion, nitrate anion, nitro anion, halogen anion, PF₆⁻ anion, or tetrafluoroborate anion.

In one embodiment, the ionic liquid comprises one or more compounds having an imidazolium cation. In another embodiment, the ionic liquid comprises one or more compounds comprising an imidazolium cation selected from 1,3-dimethyl-imidazolium, 1-benzyl-3-methyl-imidazolium, 1-butyl-3-methyl-imidazolium, 1-ethyl-3-methyl-imidazolium, 1-hexyl-3-methyl-imidazolium, 1-methyl-3-propyl-imidazolium, 1-methyl-3-octyl-imidazolium, 1-methyl-3-tetradecyl-imidazolium, 1-methyl-3-phenyl-imidazolium, 1,2,3-trimethyl-imidazolium, 1,2-methyl-3-octyl-imidazolium, 1-butyl-2,3-dimethyl-imidazolium, 1-hexyl-2,3-methyl-imidazolium, and 1-(2-hydroxyethyl)-2,3-dimethyl-imidazolium cations.

In yet another embodiment, the ionic liquid comprises one or more compounds comprising: (i) an imidazolium cation, and (ii) an anion selected from cyanate anions. In a further embodiment, the ionic liquid comprises 1-ethyl-3-methylimidazolium dicyanamide. In another embodiment, the ionic liquid comprises one or more compounds comprising: (i) an imidazolium cation, and (ii) a tetracyanoborate anion. In one embodiment, the ionic liquid comprises 1-ethyl-3-methyl-imidazolium tetracyanoborate. In one embodiment, the ionic liquid comprises one or more compounds comprising: (i) an imidazolium cation, and (ii) a tetrakis-(p-(dimethyl(1H, 1H, 2H, 2H-per-fluorooctyl)silyl)phenyl)borate anion. In another embodiment, the ionic liquid comprises 1-ethyl-3-methylimidazolium tetrakis-(p-(dimethyl(1H, 1H, 2H, 2H-per-fluorooctyl)silyl)phenyl)borate.

In an embodiment, the polymer composition, polymer film, polymer gel, polymer foam, or polymer film, gel, or foam component of the electronic device of the present invention each comprise:
(a) at least one electrically conductive polymer,
(b) at least one salt comprising a sulfonylimide anion, and
(c) at least one ionic liquid.

In an embodiment, the ionic liquid comprises one or more compounds each comprising:
(i) an organic cation, and
(ii) an anion selected from cyanate anions, tetracyanoborate anions, tetrakis-(p-(dimethyl(1H, 1H, 2H, 2H-per-fluorooctyl)silyl)phenyl)borate anions, and hexafluorophosphate anions,
provided that, if the ionic liquid comprises a compound that comprises a hexafluorophosphate anion, then the one or more electrically conductive polymers must comprise a mixture of one or more polythiophene polymers and one or more water soluble polymeric acid dopants.

In some embodiments, the polymer composition, polymer film, polymer gel, polymer foam, or polymer film, gel, or foam component of the electronic device of the present invention may optionally further comprise electrically conductive nanostructures. As used herein, the term “nanostructures” generally refers to nano-sized structures, at least one dimension of which is less than or equal to 500 nm, more typically, less than or equal to 250 nm, or less than or equal to 100 nm, or less than or equal to 50 nm, or less than or equal to 25 nm.

The electrically conductive nanostructures can be of any shape or geometry, more typically of anisotropic geometry. Typical anisotropic nanostructures include nanofibers, nanowires and nanotubes.

The electrically conductive nanostructures can be formed of any electrically conductive material, such as for example, metallic materials or non-metallic materials, such as carbon or graphite, and may comprise a mixture of nanostructures formed form different electrically conductive materials, such as a mixture of carbon fibers and silver nanowires.

In one embodiment, the polymer composition, polymer film, polymer gel, polymer foam, or polymer film, gel, or foam component of the electronic device of the present invention further comprise one or more metallic electrically conductive nanostructures, such as, for example, silver nanowires or silver nanotubes.

In one embodiment, the polymer composition, polymer film, polymer gel, polymer foam, or polymer film, gel, or foam component of the electronic device of the present invention may each optionally further comprise one or more electrically conductive additives, such as, for example, metal particles, including metal nanoparticles and metal nanowires, graphite particles, including graphite fibers, or carbon particles, including carbon fullerenes and carbon nanotubes, and as well as combinations of any such additives. Suitable fullerenes include for example, C60, C70, and C84 fullerenes, each of which may be derivatized, for example with a (3-methoxycarbonyl)-propyl-phenyl (“PCBM”) group, such as C60-PCBM, C-70-PCBM and C-84 PCBM derivatized fullerenes. Suitable carbon nanotubes include single wall carbon nanotubes having an armchair, zigzag or chiral structure, as well as multiwall carbon nanotubes, including double wall carbon nanotubes, and mixtures thereof.

In one embodiment, the respective polymer composition, polymer film, polymer gel, polymer foam, or polymer film, gel, or foam component of the electronic device of the present invention may each optionally comprise up to about 65 pbw, more typically from about 12 to about 62 pbw carbon particles, more typically carbon nanotubes, and even more typically multi-wall carbon nanotubes, per 100 pbw of the film, gel, or foam.

In one embodiment, the polymer composition of the present invention is made by providing a solution or dispersion of the electrically conductive polymer in the liquid carrier or dissolving or dispersing the electrically conductive polymer in the liquid carrier and dissolving or dispersing the at least one salt comprising a sulfonylimide anion in the liquid carrier, typically by adding the electrically conductive polymer and the at least one salt comprising a sulfonylimide anion to the liquid carrier and agitating the mixture, more typically by providing a solution or dispersion of an electrically conductive polymer in a liquid carrier and dissolving or dispersing at least one salt comprising a sulfonylimide anion in the solution or dispersion of the electrically conductive polymer in the liquid carrier.

In one embodiment, the at least one salt comprising a sulfonylimide anion is added to a quiescent, that is, without mixing, aqueous solution or dispersion of the electrically conductive polymer in the liquid carrier and then mixed. In another embodiment, an aqueous solution or dispersion of electrically conductive polymer in the liquid carrier is mixed and the at least one salt comprising a sulfonylimide anion is added to the aqueous dispersion of the electrically conductive polymer in the liquid carrier with continued mixing. In forming gel versions of the composition of the present invention, adding at least one salt comprising a sulfonylimide anion to a quiescent aqueous solution or dispersion of the electrically conductive polymer in the liquid carrier and then mixing tends to result in immediate gelation, while mixing the aqueous solution or dispersion of electrically conductive polymer in the liquid carrier and adding the at least one salt comprising a sulfonylimide anion to the aqueous dispersion of the electrically conductive polymer in the liquid carrier with continued mixing tends to delay gelation.

In one embodiment, the polymer composition of the present invention is made by mixing water and/or the water miscible polar organic liquid and/or one or more ionic liquid to form the liquid carrier, dissolving or dispersing the electrically conductive polymer in the liquid carrier, and dissolving or dispersing the salt comprising a sulfonylimide anion in the liquid carrier.

In an embodiment, the polymer composition is made by a method comprising:
(1a) dissolving or dispersing at least one electrically conductive polymer in a liquid carrier comprising water and/or at least one water miscible polar organic liquid and/or ionic liquid to form a mixture, and
(1b) adding to the mixture formed in step (1a) at least one salt comprising a sulfonylimide anion in a substantially dry form, thereby making the polymer composition.

In an embodiment, the at least one salt comprising a sulfonylimide anion in a substantially dry form contains less than 5 wt % water. In another embodiment, the at least one salt comprising a sulfonylimide anion contains less than 2 wt % water. In yet another embodiment, the at least one salt comprising a sulfonylimide anion contains less than 0.5 wt % water.

In an embodiment, the polymer composition is made by a method comprising:
(2a) dissolving or dispersing at least one electrically conductive polymer in a first liquid carrier comprising water and/or at least one water miscible polar organic liquid and/or ionic liquid to form a first mixture,
(2b) dissolving or dispersing at least one salt comprising a sulfonylimide anion in a second liquid carrier comprising water and/or at least one water miscible polar organic liquid and/or ionic liquid to form a second mixture, and
(2c) contacting the first mixture formed in step (a) with the second mixture formed in step (2b), thereby making the polymer composition.

In an embodiment, the second liquid carrier in step (2b) comprises at least one water miscible polar organic liquid, at least one ionic liquid or any combination thereof.

In one embodiment, an electrically conductive polymer film according to the present invention is made by a method comprising:
(1) forming a layer of a polymer composition described herein, and
(2) removing the liquid carrier from the layer.

In one embodiment, an electrically conductive polymer film according to the present invention is made from the polymer composition of the present invention by depositing a layer of the polymer composition by, for example, casting, spray coating, spin coating, gravure coating, curtain coating, dip coating, slot-die coating, ink jet printing, gravure printing, or screen printing, on a substrate and removing the liquid carrier from the layer. Typically, the liquid carrier is removed from the layer by allowing the liquid carrier component of the layer to evaporate. The substrate supported layer may be subjected to elevated temperature to encourage evaporation of the liquid carrier.

In another embodiment, an electrically conductive polymer film according to the present invention is made by a method comprising:
(1) forming a layer of a polymer composition, said polymer composition comprising;
   (a) a liquid carrier comprising water and, optionally, at least one water miscible polar organic liquid,
   (b) at least one electrically conductive polymer dissolved or dispersed in the liquid carrier,
(2) removing the liquid carrier from the layer to form a polymer film,
(3) contacting the polymer film with a solution of at least one salt comprising a sulfonylimide anion in a second liquid carrier, wherein the second liquid carrier comprises water, at least one water miscible polar organic liquid, or a mixture of water and at least one water miscible polar organic liquid, and
(4) removing the liquid carrier from the polymer film.

In another embodiment, an electrically conductive polymer film according to the present invention is made by:
(1) providing a film of an electrically conductive polymer,
(2) contacting the film with a solution of at least one salt comprising a sulfonylimide anion in a liquid carrier, wherein the liquid carrier comprises water, at least one water miscible polar organic liquid, or a mixture of water and at least one water miscible polar organic liquid, and
(3) removing the liquid carrier from the polymer film.

The substrate on which the layer is formed may be rigid or flexible and may comprise, for example, a metal, a polymer, a glass, a paper, or a ceramic material. In one embodiment, the substrate is a flexible plastic sheet. In one embodiment, the substrate is a flexible plastic sheets comprising a polymer selected from polyesters, polysulfones, polyethersulfones, polyarylates, polyimides, polyetherimides, polytetrafluoroethylenes, poly(ether ketone)s, poly(ether ether ketone)s, poly ((meth)acrylate)s, polycarbonates, polyolefins, and mixture thereof.

In one embodiment, the polymer film of the present invention is not redispersible in the liquid carrier, and the film can thus be applied as a series of multiple thin films. In addition, the film can be overcoated with a layer of different material dispersed in the liquid carrier without being damaged.

When the polymer film of the present invention is applied as a series of multiple thin films, any method known to one of ordinary skill in the art may be used to form each layer, such as, for example, casting, spray coating, spin coating, gravure coating, curtain coating, dip coating, slot-die coating, ink jet printing, gravure printing, rod or bar coating, doctor-blade coating, or screen printing, on a previously-formed layer. Each layer of a series of multiple thin films may be formed using a method different from the method used to form a previously-formed layer.

In one embodiment, the polymer composition is a polymer solution, wherein the electrically conductive polymer component of the composition is soluble in the liquid medium.

The polymer film may cover an area of the substrate that is as large as an entire electronic device or as small as a specific functional area such as the actual visual display, or as small as a single sub-pixel.

There is no particular limitation to the thickness of the polymer film and may be adapted according to its use. In one embodiment, the polymer film has a thickness of from greater than 0 to about 10 μm, more typically from 0 to about 50 nm.

The polymer film according to the present invention typically exhibits high conductivity and high optical transparency and is useful as a layer in an electronic device in which the high conductivity is desired in combination with optical transparency.

In one embodiment, the respective polymer film of the present invention and polymer film component of the electronic device of the present invention each exhibit a sheet resistance of less than or equal to 1000 Ohms per square (“Ω/□”), or less than or equal to 100Ω/□, or less than or equal to 20Ω/□, or less than or equal to 15Ω/□, or less than or equal to 10Ω/□, or less than or equal to 5Ω/□, or less than or equal to 1Ω/□, or less than or equal to 0.1 Ω/□.

In one embodiment, the respective polymer film of the present invention and polymer film component of the electronic device of the present invention each exhibit an optical transmittance at 550 nm of greater than or equal to 1%, or greater than or equal to 50%, or greater than or equal to 70%, or greater than or equal to 80%, or greater than or equal to 90%.

In one embodiment, the respective polymer film of the present invention and polymer film component of the electronic device of the present invention each exhibit a sheet resistance of less than or equal to 1000Ω/□ or less than or equal to 100Ω/□, or less than or equal to 20Ω/□, or less than or equal to 15Ω/□, or less than or equal to 10Ω/□, or less than or equal to 5Ω/□, or less than or equal to 1Ω/□, or less than or equal to 0.1Ω/□ and an optical transmittance at 550 nm of greater than or equal to 1%, or greater than or equal to 50%, or greater than or equal to 70%, or than or equal to 80%, or greater than or equal to 90%.

In one embodiment, the respective polymer film of the present invention and polymer film component of the electronic device of the present invention each exhibit a sheet resistance of less than or equal to 100Ω and an optical transmittance at 550 nm of greater than or equal to 90%.

In one embodiment, the respective polymer film of the present invention and polymer film component of the electronic device of the present invention each exhibit a sheet resistance of less than or equal to 15Ω and an optical transmittance at 550 nm of greater than or equal to 70%.

In one embodiment, the respective polymer film of the present invention and polymer film component of the electronic device of the present invention each exhibit a sheet resistance of less than or equal to 5Ω/□ and an optical transmittance at 550 nm of greater than or equal to 50%.

In one embodiment, the electrically conductive foam of the present invention is made by contacting, in an aqueous liquid medium, the electrically conductive polymer with an amount of a salt comprising a sulfonylimide anion effective to gel the electrically conductive polymer, and removing the aqueous liquid medium from the gel to form the polymer foam. In one embodiment, the liquid medium is removed from the gel by freeze-drying the gel.

In one embodiment, the aqueous gel of the present invention comprises, based on 100 pbw of the gel,
(A) from about 2 pbw to about 90 pbw of a polymer network, based on 100 pbw of the polymer network:
   (i) from about 10 to about 40 pbw, more typically from about 15 to about 35 pbw, and even more typically from about 20 to about 35 pbw of an electrically conductive polymer comprising a mixture of, based on 100 pbw of the mixture:
      (1) from about 20 to about 50 pbw of poly(3,4-ethylenedioxythiophene), and
      (2) from about 50 to about 80 pbw of poly(styrene sulfonic acid) dopant, and
   (ii) from about 60 to about 90 pbw, more typically from about 65 to about 85 pbw, and even more typically from about 65 to about 80 pbw of at least one salt comprising a sulfonylimide anion,
(B) from about 10 pbw to about 98 pbw of an aqueous liquid medium,
   wherein the ratio of the total amount by weight of the at least one salt comprising a sulfonylimide anion in such film to the total amount by weight of the electrically conductive polymer in such film is typically from about 1.5:1 to about 45:1, more typically from 1.7:1 to 20:1, even more typically from about 1.7:1 to about 10:1, and still more typically from 2:1 to 8:1.

In one embodiment, the respective polymer gel of the present invention and polymer gel component of the electronic device of the present invention each exhibit a sheet resistance of less than or equal to 50Ω/□, more typically, of less than or equal to 10 Ω/□.

In one embodiment, the polymer foam of the present invention and polymer foam component of the electronic device of the present invention each comprise the product obtained by contacting, based on 100 pbw of the polymer foam:
(i) from about 10 to about 40 pbw, more typically from about 15 to about 35 pbw, and even more typically from about 20 to about 35 pbw of an electrically conductive polymer comprising a mixture of, based on 100 pbw of the mixture:
   (1) from about 20 to about 50 pbw of poly(3,4-ethylenedioxythiophene), and
   (2) from about 50 to about 80 pbw of poly(styrene sulfonic acid) dopant, and
(ii) from about 60 to about 90 pbw, more typically from about 65 to about 85 pbw, and even more typically from about 65 to about 80 pbw of at least one salt comprising a sulfonylimide anion,
   wherein the ratio of the total amount by weight of the at least one salt comprising a sulfonylimide anion in such film to the total amount by weight of the electrically conductive polymer in such film is typically from about 1.5:1 to about 45:1, more typically from 1.7:1 to 20:1, even more typically from about 1.7:1 to about 10:1, and still more typically from 2:1 to 8:1.

The electronic device of the present invention may be any device that comprises one or more layers of semiconductor materials and makes use of the controlled motion of electrons through such one or more layers, such as, for example:

a device that converts electrical energy into radiation, such as, for example, a light-emitting diode, light emitting diode display, diode laser, a liquid crystal display, or lighting panel,

a device that detects signals through electronic processes, such as, for example, a photodetector, photoconductive cell, photoresistor, photoswitch, phototransistor, phototube, infrared (“IR”) detector, biosensor, or a touch screen display device,

a device that converts radiation into electrical energy, such as, for example, a photovoltaic device or solar cell, and

a device that includes one or more electronic components with one or more semiconductor layers, such as, for example, a transistor or diode.

In one embodiment, polymer film according to the present invention is used as an electrode layer, more typically, an anode layer, of an electronic device.

In one embodiment, the polymer film according to the present invention is used as a buffer layer of an electronic device.

In one embodiment, a polymer film according to the present invention is used as a combined electrode and buffer layer, typically a combined anode and buffer layer, of an electronic device.

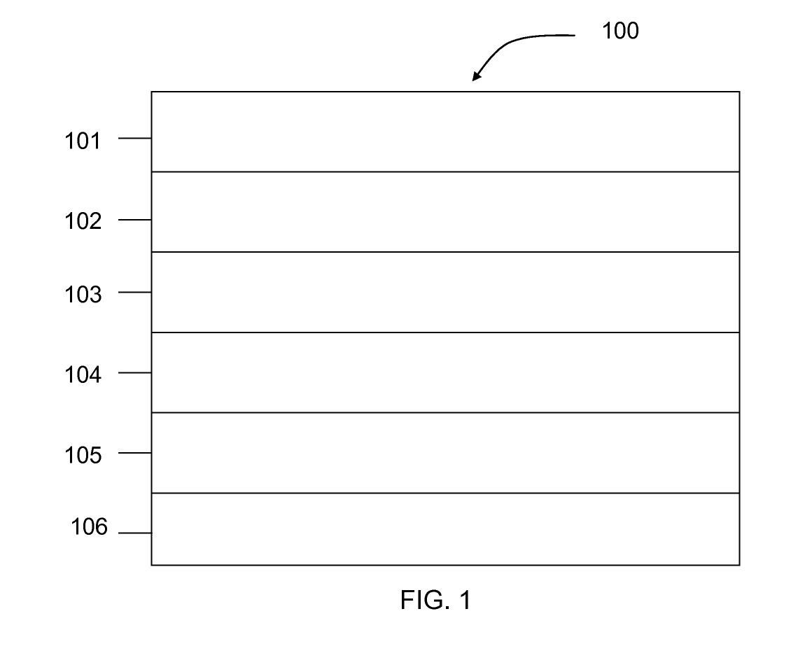

In one embodiment, the electronic device of the present invention is an electronic device 100, as shown in FIG. 1, having an anode layer 101, an electroactive layer 104, and a cathode layer 106 and optionally further having a buffer layer 102, hole transport layer 103, and/or electron injection/transport layer or confinement layer 105, wherein at least one of the layers of the device is a polymer film according to the present invention. The device 100 may further include a support or substrate (not shown), that can be adjacent to the anode layer 101 or the cathode layer 106. more typically, adjacent to the anode layer 101. The support can be flexible or rigid, organic or inorganic. Suitable support materials include, for example, glass, ceramic, metal, and plastic films.

In one embodiment, anode layer 101 of device 100 comprises a polymer film according to the present invention. The polymer film of the present invention is particularly suitable as anode layer 106 of device 100 because of its high electrical conductivity.

In one embodiment, anode layer 101 itself has a multilayer structure and comprises a layer of the polymer film according to the present invention, typically as the top layer of the multilayer anode, and one or more additional layers, each comprising a metal, mixed metal, alloy, metal oxide, or mixed oxide. Suitable materials include the mixed oxides of the Group 2 elements (i.e., Be, Mg, Ca, Sr, Ba, Ra), the Group 11 elements, the elements in Groups 4, 5, and 6, and the Group 8-10 transition elements. If the anode layer 101 is to be light transmitting, mixed oxides of Groups 12, 13 and 14 elements, such as indium-tin-oxide, may be used. As used herein, the phrase “mixed oxide” refers to oxides having two or more different cations selected from the Group 2 elements or the Groups 12, 13, or 14 elements. Some non-limiting, specific examples of materials for anode layer 101 include, but are not limited to, indium-tin-oxide, indium-zinc-oxide, aluminum-tin-oxide, gold, silver, copper, and nickel. The mixed oxide layer may be formed by a chemical or physical vapor deposition process or spin-cast process. Chemical vapor deposition may be performed as a plasma-enhanced chemical vapor deposition (“PECVD”) or metal organic chemical vapor deposition (“MOCVD”). Physical vapor deposition can include all forms of sputtering, including ion beam sputtering, as well as e-beam evaporation and resistance evaporation. Specific forms of physical vapor deposition include radio frequency magnetron sputtering and inductively-coupled plasma physical vapor deposition (“IMP-PVD”). These deposition techniques are well known within the semiconductor fabrication arts.

In one embodiment, the mixed oxide layer is patterned. The pattern may vary as desired. The layers can be formed in a pattern by, for example, positioning a patterned mask or resist on the first flexible composite barrier structure prior to applying the first electrical contact layer material. Alternatively, the layers can be applied as an overall layer (also called blanket deposit) and subsequently patterned using, for example, a patterned resist layer and wet chemical or dry etching techniques. Other processes for patterning that are well known in the art can also be used.

In one embodiment, device 100 comprises a buffer layer 102 and the buffer layer 102 comprises a polymer film according to the present invention.

In one embodiment, a separate buffer layer 102 is absent and anode layer 101 functions as a combined anode and buffer layer. In one embodiment, the combined anode/buffer layer 101 comprises a polymer film according to the present invention.

In some embodiments, optional hole transport layer 103 is present, either between anode layer 101 and electroactive layer 104, or, in those embodiments that comprise buffer layer 102, between buffer layer 102 and electroactive layer 104. Hole transport layer 103 may comprise one or more hole transporting molecules and/or polymers. Commonly used hole transporting molecules include, but are not limited to: 4,4′,4″-tris(N,N-diphenyl-amino)-triphenylamine, 4,4′,4″-tris(N-3-methylphenyl-N-phenyl-amino)-triphenylamine, N,N′-diphenyl-N,N′-bis(3-methylphenyl)-(1,1′-biphenyl)-4,4′-diamine, 1,1-bis((di-4-tolylamino)phenyl)cyclohexane, N,N′-bis(4-methylphenyl)-N,N′-bis(4-ethylphenyl)-(1,1′-(3,3′-dimethyl)biphenyl)-4,4′-diamine, tetrakis-(3-methylphenyl)-N,N,N′,N′-2,5-phenylenediamine, .alpha-phenyl-4-N,N-diphenylaminostyrene, p-(diethylamino)benzaldehyde diphenylhydrazone, triphenylamine, bis(4-(N,N-diethylamino)-2-methylphenyl)(4-methylphenyl)methane, 1-phenyl-3-(p-(diethylamino)styryl)-5-(p-(diethylamino)phenyl)pyrazoline, 1,2-trans-bis(9H-carbazol-9-yl)cyclobutane, N,N,N′,N′-tetrakis(4-methylphenyl)-(1,1′-biphenyl)-4,4′-diamine, N,N′-bis(naphthalen-1-yl)-N,N′-bis-(phenyl)benzidine, and porphyrinic compounds, such as copper phthalocyanine. Commonly used hole transporting polymers include, but are not limited to, polyvinylcarbazole, (phenylmethyl)polysilane, poly(dioxythiophenes), polyanilines, and polypyrroles. It is also possible to obtain hole transporting polymers by doping hole transporting molecules, such as those mentioned above, into polymers such as polystyrene and polycarbonate.

The composition of electroactive layer 104 depends on the intended function of device 100, for example, electroactive layer 104 can be a light-emitting layer that is activated by an applied voltage (such as in a light-emitting diode or light-emitting electrochemical cell), or a layer of material that responds to radiant energy and generates a signal with or without an applied bias voltage (such as in a photodetector). In one embodiment, electroactive layer 104 comprises an organic electroluminescent (“EL”) material, such as, for example, electroluminescent small molecule organic compounds, electroluminescent metal complexes, and electroluminescent conjugated polymers, as well as mixtures thereof. Suitable EL small molecule organic compounds include, for example, pyrene, perylene, rubrene, and coumarin, as well as derivatives thereof and mixtures thereof. Suitable EL metal complexes include, for example, metal chelated oxinoid compounds, such as tris(8-hydroxyquinolate)aluminum, cyclo-metallated iridium and platinum electroluminescent compounds, such as complexes of iridium with phenylpyridine, phenylquinoline, or phenylpyrimidine ligands as disclosed in Petrov et al., U.S. Pat. No. 6,670,645, and organometallic complexes such as those described in, for example, Published PCT Applications WO 03/008424, as well as mixtures any of such EL metal complexes. Examples of EL conjugated polymers include, but are not limited to poly(phenylenevinylenes), polyfluorenes, poly(spirobifluorenes), polythiophenes, and poly(p-phenylenes), as well as copolymers thereof and mixtures thereof.

Optional layer 105 can function as an electron injection/transport layer and/or a confinement layer. More specifically, layer 105 may promote electron mobility and reduce the likelihood of a quenching reaction if layers 104 and 106 would otherwise be in direct contact. Examples of materials suitable for optional layer 105 include, for example, metal chelated oxinoid compounds, such as bis(2-methyl-8-quinolinolato)(para-phenyl-phenolato)aluminum(III) and tris(8-hydroxyquinolato)aluminum, tetrakis(8-hydroxyquinolinato)zirconium, azole compounds such as 2-(4-biphenylyl)-5-(4-t-butylphenyl)-1,3,4-oxadiazole, 3-(4-biphenylyl)-4-phenyl-5-(4-t-butylphenyl)-1,2,4-triazole, and 1,3,5-tri(phenyl-2-benzimidazole)benzene, quinoxaline derivatives such as 2,3-bis(4-fluorophenyl)quinoxaline, phenanthroline derivatives such as 9,10-diphenylphenanthroline and 2,9-dimethyl-4,7-diphenyl-1,10-phenanthroline, and as well as mixtures thereof. Alternatively, optional layer 105 may comprise an inorganic material, such as, for example, BaO, LiF, Li₂O.

Cathode layer 106 can be any metal or nonmetal having a lower work function than anode layer 101. In one embodiment, anode layer 101 has a work function of greater than or equal to about 4.4 eV and cathode layer 106 has a work function less than about 4.4 eV. Materials suitable for use as cathode layer 106 are known in the art and include, for example, alkali metals of Group 1, such as Li, Na, K, Rb, and Cs, Group 2 metals, such as, Mg, Ca, Ba, Group 12 metals, lanthanides such as Ce, Sm, and Eu, and actinides, as well as aluminum, indium, yttrium, and combinations of any such materials. Specific non-limiting examples of materials suitable for cathode layer 106 include, but are not limited to, Barium, Lithium, Cerium, Cesium, Europium, Rubidium, Yttrium, Magnesium, Samarium, and alloys and combinations thereof. Cathode layer 106 is typically formed by a chemical or physical vapor deposition process. In some embodiments, the cathode layer will be patterned, as discussed above in reference to the anode layer 101.

In one embodiment, an encapsulation layer (not shown) is deposited over cathode layer 106 to prevent entry of undesirable components, such as water and oxygen, into device 100. Such components can have a deleterious effect on electroactive layer 104. In one embodiment, the encapsulation layer is a barrier layer or film. In one embodiment, the encapsulation layer is a glass lid.

Though not shown in FIG. 1, it is understood that device 100 may comprise additional layers. Other layers that are known in the art or otherwise may be used. In addition, any of the above-described layers may comprise two or more sub-layers or may form a laminar structure. Alternatively, some or all of anode layer 101, buffer layer 102, hole transport layer 103, electron transport layer 105, cathode layer 106, and any additional layers may be treated, especially surface treated, to increase charge carrier transport efficiency or other physical properties of the devices. The choice of materials for each of the component layers is preferably determined by balancing the goals of providing a device with high device efficiency with device operational lifetime considerations, fabrication time and complexity factors and other considerations appreciated by persons skilled in the art. It will be appreciated that determining optimal components, component configurations, and compositional identities would be routine to those of ordinary skill of in the art.

The various layers of the electronic device can be formed by any conventional deposition technique, including vapor deposition, liquid deposition (continuous and discontinuous techniques), and thermal transfer. Continuous deposition techniques, include but are not limited to, spin coating, gravure coating, curtain coating, dip coating, slot-die coating, spray coating, and continuous nozzle coating. Discontinuous deposition techniques include, but are not limited to, ink jet printing, gravure printing, and screen printing. Other layers in the device can be made of any materials which are known to be useful in such layers upon consideration of the function to be served by such layers.

In one embodiment of the device 100, the different layers have the following range of thicknesses:

anode layer 101, typically 500-5000 Angstroms (“Å”), more typically, 1000-2000 Å,

optional buffer layer 102: typically 50-2000 Å, more typically, 200-1000 Å,

optional hole transport layer 103: typically 50-2000 Å, more typically, 100-1000 Å,

photoactive layer 104: typically, 10-2000 Å, more typically, 100-1000 Å,

optional electron transport layer: typically 105, 50-2000 Å, more typically, 100-1000 Å, and

cathode layer 106: typically 200-10000 Å, more typically, 300-5000 Å.

As is known in the art, the location of the electron-hole recombination zone in the device, and thus the emission spectrum of the device, can be affected by the relative thickness of each layer. The appropriate ratio of layer thicknesses will depend on the exact nature of the device and the materials used.

In one embodiment, the electronic device of the present invention, comprises:
(a) an anode or combined anode and buffer layer 101,
(b) a cathode layer 106,
(c) an electroactive layer 104, disposed between anode layer 101 and cathode layer 106,
(d) optionally, a buffer layer 102, typically disposed between anode layer 101 and electroactive layer 104,
(e) optionally, a hole transport layer 105, typically disposed between anode layer 101 and electroactive layer 104, or if buffer layer 102 is present, between buffer layer 102 and electroactive layer 104, and
(f) optionally an electron injection layer 105, typically disposed between electroactive layer 104 and cathode layer 106,
   wherein at least one of the layers of the device, typically at least one of the anode or combined anode and buffer layer 101 and, if present, buffer layer 102 comprises a polymer film according to the present invention, that is, a polymer film comprising a mixture of:
   (i) an electrically conductive polymer, and
   (ii) anisotropic electrically conductive nanostructures.

In one embodiment, the electronic device of the present invention is a device for converting electrical energy into radiation, and comprises an anode 101 that comprises a polymer film according to the present invention, a cathode layer 106, an electroactive layer 104 that is capable of converting electrical energy into radiation, disposed between the anode layer 101 layer and the cathode layer 106, and optionally further comprising a buffer layer 102, a hole transport layer 103, and/or an electron injection layer 105. In one embodiment, the device is a light emitting diode (“LED”) device and the electroactive layer 104 of the device is an electroluminescent material, even more typically, and the device is an organic light emitting diode (“OLED”) device and the electroactive layer 104 of the device is organic electroluminescent material. In one embodiment, the OLED device is an “active matrix” OLED display, wherein, individual deposits of photoactive organic films may be independently excited by the passage of current, leading to individual pixels of light emission. In another embodiment, the OLED is a “passive matrix” OLED display, wherein deposits of photoactive organic films may be excited by rows and columns of electrical contact layers.

In one embodiment, the electronic device of the present invention is a device for converting radiation into electrical energy, and comprises an anode 101 that comprises a polymer film according to the present invention, a cathode layer 106, an electroactive layer 104 comprising a material that is capable of converting radiation into electrical energy, disposed between the anode layer 101 layer and the cathode layer 106, and optionally further comprising a buffer layer 102, a hole transport layer 103, and/or an electron injection layer 105.

In operation of one embodiment of device 100, such as a device for converting electrical energy into radiation, a voltage from an appropriate power supply (not depicted) is applied to device 100 so that an electrical current passes across the layers of the device 100 and electrons enter electroactive layer 104, and are converted into radiation, such as in the case of an electroluminescent device, a release of photon from electroactive layer 104.

In operation of another embodiment of device 100, such as device for converting radiation into electrical energy, device 100 is exposed to radiation impinges on electroactive layer 104, and is converted into a flow of electrical current across the layers of the device.

In one embodiment, the electronic device of the present invention is a battery, namely a battery cell.

Generally, a battery cell comprises a first electrode, at least one electrolyte, and a second electrode, wherein the first and second electrodes optionally contain a base metal or a material into/from which ions of a base metal can be inserted and desorbed.

The first electrode, the at least one electrolyte, and/or the second electrode may each comprise the polymer film, gel, or foam of the present invention.

In one embodiment, the first electrode is a cathode or cathode material. In one embodiment, the cathode or cathode material comprises a metal oxide, for example, lithium nickel oxide or a lithium metal oxide. In one embodiment, the cathode material utilized can comprise, but is not limited to, transition-metals, metal oxides, and the like. In another embodiment, the cathode material comprises at least aluminum, titanium, nickel, and/or alloys of these metals. In one embodiment, the cathode or cathode material comprises a polymer film, gel, or foam of the present invention.

In one embodiment, the second electrode is an anode or anode material. In one embodiment, the anode or anode material comprises, but is not limited to, graphite, copper, and the like. In one embodiment, the anode or anode material comprises a polymer film, gel, or foam of the present invention.

The at least one electrolyte can be any material capable of conducting ions from one electrode to the other opposite electrode in a battery cell. In one embodiment, the at least one electrolyte comprises a polymer film, gel, or foam of the present invention.

In one embodiment, the electronic device 100 is a battery cell comprising an anode 101, a cathode layer 106 and an electrolyte layer 104 disposed between the anode layer and cathode layer, wherein at least one of the anode layer, the cathode layer, and electrolyte layer comprises a polymer film, gel, or foam according to the present invention. The battery cell comprising an anode 101, a cathode layer 106 and an electrolyte layer 104 disposed between the anode layer and cathode layer, wherein at least one of the anode layer, the cathode layer, and electrolyte layer comprises a polymer film, gel, or foam according to the present invention may further comprise optional layers, the use of which may be determined by those having ordinary skill in the art.

The battery cell comprising an anode 101, a cathode layer 106 and an electrolyte layer 104 disposed between the anode layer and cathode layer, wherein at least one of the anode layer, the cathode layer, and electrolyte layer comprises a polymer film, gel, or foam according to the present invention may be made to have any arbitrary shape that is rigid, flexible, bendable, and/or twistable using methods known to a person of ordinary skill in the art. For example, the anode 101, the cathode 106, and the electrolyte layer 104 may be formed into a cable-type shape wherein the anode 101, cathode 106, the electrolyte layer 104, and any optional layers, are formed into concentric cylindrical layers in a cable-type shape that is flexible, bendable, and/or twistable. The shape of the battery cell may be adapted for any application, and the battery cell may be made to be wearable and/or waterproof.

The battery cell comprising an anode 101, a cathode layer 106 and an electrolyte layer 104 disposed between the anode layer and cathode layer, wherein at least one of the anode layer, the cathode layer, and electrolyte layer comprises a polymer film, gel, or foam according to the present invention may be part of a battery pack comprising one or more battery cells. The battery pack may be made to have any arbitrary shape that is rigid, flexible, bendable, and/or twistable using methods known to a person of ordinary skill in the art.

The present invention is further illustrated by the following non-limiting examples.

### Examples 1-5 and Comparative Example C1

The compositions of Example 1-5 (and C1) were made by mixing the components listed below:

| | |
|---|---|
| PEDOT:PSS | Aqueous dispersion containing 1.3 wt % of poly(3,4- |
| | ethylenedioxythiophene:poly(styrene sulfonic acid) blend |
| | (Clevios PH 1000, Heraeus) |
| LiTFSI | Lithium bis(trifluoromethanesulfonyl)imide |
| | (Solvay product) |

The compositions of Examples 1-5 were made by adding LiTFSI in the amounts set forth below in TABLE IA to 1 gram of a 1.3% aqueous dispersion of PEDOT:PSS (Clevios PH 1000, Heraeus) and mixing. The composition of Comparative Example C1 was made in an analogous way, except that no salt was included. Each of the compositions of Examples 1-5 and Comparative Example C1 was spin-coated at 4000 revolutions per minute on a glass substrate to form a film of the composition (The spin-coated films were then annealed for 15 minutes at 130° C. The sheet resistance of each film was measured using four probe tester (Jandel RM3-AR). The amount of LiTFSI (expressed as grams (“g”) LiTFSI per 0.013 g PEDOT:PSS polymer) in each polymer/LiTFSI dispersion, the ratio (wt:wt) of LiTFSI to PEDOT:PSS polymer in the aqueous polymer/LiTFSI dispersion, parts by weight (“pbw”) of LiTFSI in each coating composition, parts by weight (“pbw”) of PEDOT:PSS polymer in each composition, parts by weight (“pbw”) of the liquid carrier in composition, and the Sheet Resistance in ohms per square (Ω/□) are summarized for each of Examples 1-5 and Comparative Example C1 in TABLES IA and IB, respectively, below.

TABLE IA

| | Example # | | | | |
|---|---|---|---|---|---|
| | 1 | 2 | 3 | 4 | 5 |
| Amount of LiTFSI used | 0.55 | 0.85 | 1.45 | 2.50 | 2.87 |
| with respect to amount | | | | | |
| of PEDOT:PSS | | | | | |
| dispersion used (wt %) | | | | | |
| Amount of LiTFSI (g) | 0.0055 | 0.0085 | 0.0145 | 0.0250 | 0.0287 |
| per 0.013 g | | | | | |
| PEDOT:PSS polymer | | | | | |
| Ratio (wt:wt) of LiTFSI | 0.42:1 | 0.65:1 | 1.12:1 | 1.92:1 | 2.21:1 |
| to PEDOT:PSS polymer | | | | | |
| Parts by weight (“pbw”) | 0.54 | 0.84 | 1.44 | 2.44 | 2.79 |
| of LiTFSI in composition | | | | | |
| Parts by weight (“pbw”) | 1.29 | 1.29 | 1.28 | 1.27 | 1.26 |
| of PEDOT:PSS polymer | | | | | |
| in composition | | | | | |
| Parts by weight (“pbw”) | 98.16 | 97.87 | 97.28 | 96.30 | 95.94 |
| of liquid carrier in | | | | | |
| composition | | | | | |
| Resistance (Ω/□) | 61300 | 740 | 350 | 444 | 366 |

TABLE IB

| | Comparative Example # |
|---|---|
| | C1 |
| Amount of LiTFSI used | 0 |
| with respect to amount | |
| of PEDOT:PSS | |
| dispersion used (wt %) | |
| Amount of LiTFSI (g) | 0 |
| per 0.013 g | |
| PEDOT:PSS polymer | |
| Ratio (wt:wt) of LiTFSI | No LiTFSI added |
| to PEDOT:PSS polymer | |
| Parts by weight (“pbw”) | 0 |
| of LiTFSI in composition | |
| Parts by weight (“pbw”) | 1.30 |
| of PEDOT:PSS polymer | |
| in composition | |
| Parts by weight (“pbw”) | 98.70 |
| of liquid carrier in | |
| composition | |
| Resistance (Ω/□) | 145000 |

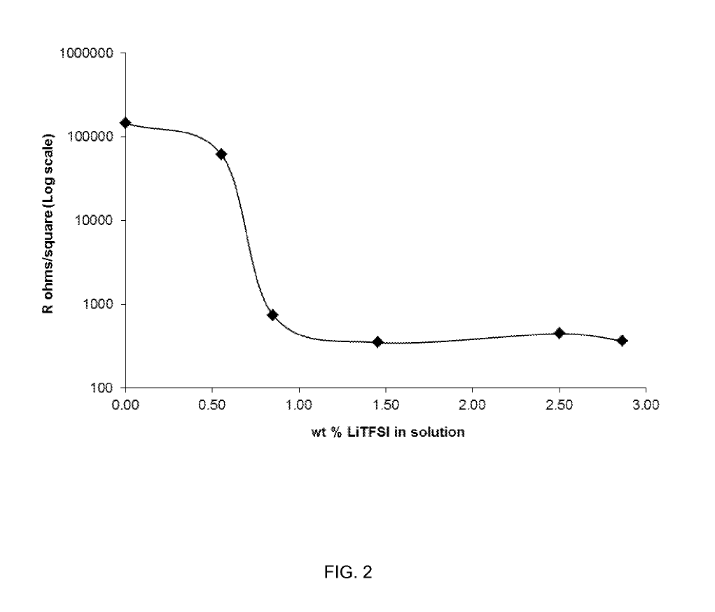

A plot of sheet resistance, expressed in Ohms per square (“ohms/square”), of the films formed from the coating compositions of Examples 1-5 and Comparative Example C1 versus the amount of lithium bis(trifluoromethanesulfonyl)imide (LiTFSI) used, expressed as percent by weight (“wt %”) with respect to PEDOT:PSS polymer dispersion, is shown in FIG. 2.

### Examples 6-19

The coating compositions of Examples 6-19 were made by adding LiTFSI in the amounts set forth below in TABLES IIA, IIB, IIIA, and IIIB to 1 gram of a 1.3% aqueous dispersion of PEDOT:PSS (Clevios PH 1000, Heraeus) and mixing. The LiTFSI was added as a pure substance to PEDOT:PSS. The resulting compositions were then immediately formed into the corresponding films using a bar coater (Coatmaster 510, Erichsen). In Examples 6-12, the films were each formed to have a wet thickness of 10 μm. In Examples 13-19, the films were each formed to have a wet thickness of 20 μm. The sheet resistance of each film was measured at least four times using a four probe tester (Jandel RM3-AR) to arrive at an arithmetic average sheet resistance. The transmittance and haze of each film were measured using Haze-guard Plus hazemeter (BYK). The amount of LiTFSI (expressed as grams (“g”) LiTFSI per 0.013 g PEDOT:PSS polymer) in each polymer/LiTFSI dispersion, the ratio (wt:wt) of LiTFSI to PEDOT:PSS polymer in the aqueous polymer/LiTFSI dispersion, parts by weight (“pbw”) of LiTFSI in each coating composition, parts by weight (“pbw”) of PEDOT:PSS polymer in each composition, parts by weight (“pbw”) of the liquid carrier in composition, wet thickness, the average sheet resistance in ohms per square (Ω/□), transmittance, and haze are summarized for each of Examples 6-12 in TABLES IIA and IIB, and Examples 13-19 in TABLES IIIA and IIIB below.

TABLE IIA

| | Example # | | | | |
|---|---|---|---|---|---|
| | 6 | 7 | 8 | 9 | 10 |
| Amount of LiTFSI used | 0.53 | 0.96 | 1.55 | 2.20 | 3.00 |
| with respect to amount | | | | | |
| of PEDOT:PSS | | | | | |
| dispersion used (wt %) | | | | | |
| Amount of LiTFSI (g) | 0.0053 | 0.0096 | 0.0155 | 0.0220 | 0.0300 |
| per 0.013 g | | | | | |
| PEDOT:PSS polymer | | | | | |
| Ratio (wt:wt) of LiTFSI | 0.41:1 | 0.74:1 | 1.19:1 | 1.69:1 | 2.31:1 |
| to PEDOT:PSS polymer | | | | | |
| Parts by weight (“pbw”) | 0.53 | 0.95 | 1.52 | 2.15 | 2.92 |
| of LiTFSI in composition | | | | | |
| Parts by weight (“pbw”) | 1.29 | 1.29 | 1.28 | 1.27 | 1.26 |
| of PEDOT:PSS polymer | | | | | |
| in composition | | | | | |
| Parts by weight (“pbw”) | 98.18 | 97.76 | 97.20 | 96.58 | 95.82 |
| of liquid carrier in | | | | | |
| composition | | | | | |
| Wet thickness (μm) | 10 | 10 | 10 | 10 | 10 |
| Average resistance | 3587.9 | 184.7 | 226.4 | 234.4 | 245.8 |
| (Ω/□) | | | | | |
| T (%) | 89.1 | 88.5 | 89 | 89.2 | 88.5 |
| Haze | 0.17 | 0.28 | 0.18 | 0.22 | 0.29 |

TABLE IIB

Example #

| | 11 | 12 |
|---|---|---|
| Amount of LiTFSI used | 4.50 | 10.00 |
| with respect to amount | | |
| of PEDOT:PSS | | |
| dispersion used (wt %) | | |
| Amount of LiTFSI (g) | 0.0450 | 0.100 |
| per 0.013 g | | |
| PEDOT:PSS polymer | | |
| Ratio (wt:wt) of LiTFSI | 3.46:1 | 7.69:1 |
| to PEDOT:PSS polymer | | |
| Parts by weight (“pbw”) | 4.30 | 9.09 |
| of LiTFSI in composition | | |
| Parts by weight (“pbw”) | 1.24 | 1.18 |
| of PEDOT:PSS polymer | | |
| in composition | | |
| Parts by weight (“pbw”) | 94.45 | 89.73 |
| of liquid carrier in | | |
| composition | | |
| Wet thickness (μm) | 10 | 10 |
| Average resistance | 314.0 | 328.8 |
| (Ω/□) | | |
| T (%) | 89.3 | 89.7 |
| Haze | 0.40 | 0.62 |

TABLE IIIA

| | Example # | | | | |
|---|---|---|---|---|---|
| | 13 | 14 | 15 | 16 | 17 |
| Amount of LiTFSI used | 0.53 | 0.96 | 1.55 | 2.20 | 3.00 |
| with respect to amount | | | | | |
| of PEDOT:PSS | | | | | |
| dispersion used (wt %) | | | | | |
| Amount of LiTFSI (g) | 0.0053 | 0.0096 | 0.0155 | 0.0220 | 0.0300 |
| per 0.013 g | | | | | |
| PEDOT:PSS polymer | | | | | |
| Ratio (wt:wt) of LiTFSI | 0.41:1 | 0.74:1 | 1.19:1 | 1.69:1 | 2.31:1 |
| to PEDOT:PSS polymer | | | | | |
| Parts by weight (“pbw”) | 0.53 | 0.95 | 1.52 | 2.15 | 2.92 |
| of LiTFSI in composition | | | | | |
| Parts by weight (“pbw”) | 1.29 | 1.29 | 1.28 | 1.27 | 1.26 |
| of PEDOT:PSS polymer | | | | | |
| in composition | | | | | |
| Parts by weight (“pbw”) | 98.18 | 97.76 | 97.20 | 96.58 | 95.82 |
| of liquid carrier in | | | | | |
| composition | | | | | |
| Wet thickness (μm) | 20 | 20 | 20 | 20 | 20 |
| Average resistance | 2639.5 | 88.8 | 60.4 | 87.3 | 147.8 |
| (Ω/□) | | | | | |
| T (%) | 79.3 | 83.4 | 79.7 | 81.7 | 85.0 |
| Haze | 0.64 | 0.32 | 0.38 | 0.35 | 0.39 |

TABLE IIIB

Example #

| | 18 | 19 |
|---|---|---|
| Amount of LiTFSI used | 4.50 | 10.00 |
| with respect to amount | | |
| of PEDOT:PSS | | |
| dispersion used (wt %) | | |
| Amount of LiTFSI (g) | 0.0450 | 0.100 |
| per 0.013 g | | |
| PEDOT:PSS polymer | | |
| Ratio (wt:wt) of LiTFSI | 3.46:1 | 7.69:1 |
| to PEDOT:PSS polymer | | |
| Parts by weight (“pbw”) | 4.30 | 9.09 |
| of LiTFSI in composition | | |
| Parts by weight (“pbw”) | 1.24 | 1.18 |
| of PEDOT:PSS polymer | | |
| in composition | | |
| Parts by weight (“pbw”) | 94.45 | 89.73 |
| of liquid carrier in | | |
| composition | | |
| Wet thickness (μm) | 20 | 20 |
| Average resistance | 36.5 | 61.0 |
| (Ω/□) | | |
| T (%) | 55.9 | 79.6 |
| Haze | 1.47 | 1.73 |

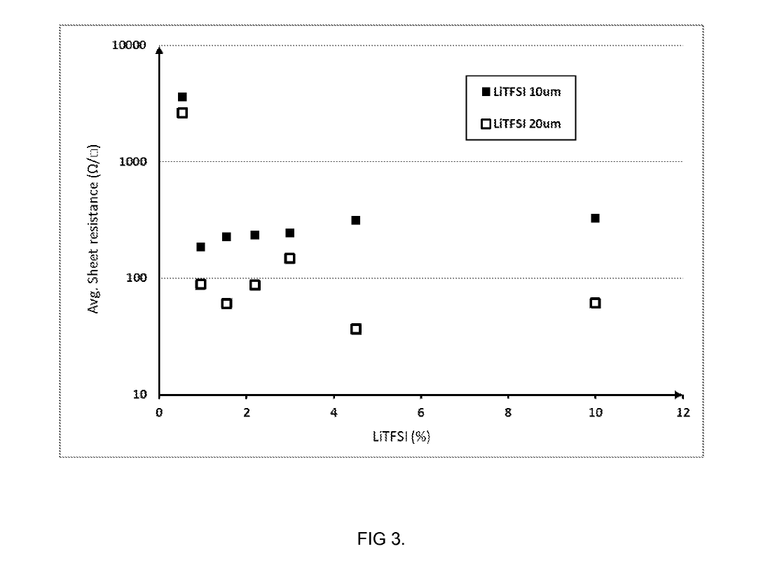

A plot of the average sheet resistance, expressed in Ohms per square (“ohms/square”), of the wet films formed from the coating compositions of Examples 6-19 versus the amount of lithium bis(trifluoromethanesulfonyl)imide (LiTFSI) used, expressed as percent by weight (“wt %”) with respect to PEDOT:PSS polymer dispersion, is shown in FIG. 3.

### Examples 20-31

The coating compositions of Examples 20-31 were made by adding LiTFSI in the amounts set forth below in TABLES IVA, IVB, IVA, and VB to 1 gram of a 1.3% aqueous dispersion of PEDOT:PSS (Clevios PH 1000, Heraeus) and mixing. The LiTFSI was added as a pure substance to PEDOT:PSS. The resulting compositions were then stirred for 24 hours prior to being formed into the corresponding films using a bar coater. In Examples 20-25, the films were each formed to have a wet thickness of 10 μm. In Examples 26-31, the films were each formed to have a wet thickness of 20 μm. The sheet resistance of each film was measured at least four times using a four probe tester (Jandel RM3-AR) to arrive at an arithmetic average sheet resistance. The transmittance and haze of each film were measured. The amount of LiTFSI (expressed as grams (“g”) LiTFSI per 0.013 g PEDOT:PSS polymer) in each polymer/LiTFSI dispersion, the ratio (wt:wt) of LiTFSI to PEDOT:PSS polymer in the aqueous polymer/LiTFSI dispersion, parts by weight (“pbw”) of LiTFSI in each coating composition, parts by weight (“pbw”) of PEDOT:PSS polymer in each composition, parts by weight (“pbw”) of the liquid carrier in composition, wet thickness, the average sheet resistance in ohms per square (Ω/□), transmittance, and haze are summarized for each of Examples 20-25 in TABLES IVA and IVB, and Examples 26-31 in TABLES VA and VB below.

TABLE IVA

| | Example # | | | | |
|---|---|---|---|---|---|
| | 20 | 21 | 22 | 23 | 24 |
| Amount of LiTFSI used | 0.51 | 0.94 | 1.54 | 2.34 | 2.97 |
| with respect to amount | | | | | |
| of PEDOT:PSS | | | | | |
| dispersion used (wt %) | | | | | |
| Amount of LiTFSI (g) | 0.0051 | 0.0094 | 0.0154 | 0.0234 | 0.0297 |
| per 0.013 g | | | | | |
| PEDOT:PSS polymer | | | | | |
| Ratio (wt:wt) of LiTFSI | 0.39 | 0.72 | 1.18 | 1.80 | 2.28 |
| to PEDOT:PSS polymer | | | | | |
| Parts by weight (“pbw”) | 0.50 | 0.93 | 1.51 | 2.29 | 2.88 |
| of LiTFSI in composition | | | | | |
| Parts by weight (“pbw”) | 1.29 | 1.29 | 1.28 | 1.27 | 1.26 |
| of PEDOT:PSS polymer | | | | | |
| in composition | | | | | |
| Parts by weight (“pbw”) | 98.20 | 97.78 | 97.21 | 96.44 | 95.86 |
| of liquid carrier in | | | | | |
| composition | | | | | |
| Wet thickness | 10 | 10 | 10 | 10 | 10 |
| (μm) | | | | | |
| Average resistance | 6513.1 | 197.6 | 162.0 | 179.6 | 170.8 |
| (Ω/□) | | | | | |
| T (%) | 89.0 | 88.1 | 89.0 | 88.0 | 86.4 |
| Haze | 0.34 | 0.27 | 0.18 | 0.33 | 0.64 |

TABLE IVB

| | Example # |
|---|---|
| | 25 |
| Amount of LiTFSI used | 4.21 |
| with respect to amount | |
| of PEDOT:PSS | |
| dispersion used (wt %) | |
| Amount of LiTFSI (g) | 0.0421 |
| per 0.013 g | |
| PEDOT:PSS polymer | |
| Ratio (wt:wt) of LiTFSI | 3.24 |
| to PEDOT:PSS polymer | |
| Parts by weight (“pbw”) | 4.04 |
| of LiTFSI in composition | |
| Parts by weight (“pbw”) | 1.25 |
| of PEDOT:PSS polymer | |
| in composition | |
| Parts by weight (“pbw”) | 94.71 |
| of liquid carrier in | |
| composition | |
| Wet thickness (μm) | 10 |
| Average resistance | 255.3 |
| (Ω/□) | |
| T (%) | 88.8 |
| Haze | 3.52 |

TABLE VA

| | Example # | | | | |
|---|---|---|---|---|---|
| | 26 | 27 | 28 | 29 | 30 |
| Amount of LiTFSI used | 0.51 | 0.94 | 1.54 | 2.34 | 2.97 |
| with respect to amount | | | | | |
| of PEDOT:PSS | | | | | |
| dispersion used (wt %) | | | | | |
| Amount of LiTFSI (g) | 0.0051 | 0.0094 | 0.0154 | 0.0234 | 0.0297 |
| per 0.013 g | | | | | |
| PEDOT:PSS polymer | | | | | |
| Ratio (wt:wt) of LiTFSI | 0.39 | 0.72 | 1.18 | 1.8 | 2.28 |
| to PEDOT:PSS polymer | | | | | |
| Parts by weight (“pbw”) | 0.50 | 0.93 | 1.51 | 2.29 | 2.88 |
| of LiTFSI in composition | | | | | |
| Parts by weight (“pbw”) | 1.29 | 1.29 | 1.28 | 1.27 | 1.26 |
| of PEDOT:PSS polymer | | | | | |
| in composition | | | | | |
| Parts by weight (“pbw”) | 98.20 | 97.78 | 97.21 | 96.44 | 95.86 |
| of liquid carrier in | | | | | |
| composition | | | | | |
| Wet thickness (μm) | 20 | 20 | 20 | 20 | 20 |
| Average resistance | 747.6 | 105.1 | 34.1 | 72.2 | 91.5 |
| (Ω/□) | | | | | |
| T (%) | 82.8 | 81.6 | 66.4 | 80.8 | 81.1 |
| Haze | 0.47 | 0.44 | 0.48 | 0.78 | 1.07 |

TABLE VB

| | Example # |
|---|---|
| | 31 |
| Amount of LiTFSI used | 4.21 |
| with respect to amount | |
| of PEDOT:PSS | |
| dispersion used (wt %) | |
| Amount of LiTFSI (g) | 0.0421 |
| per 0.013 g | |
| PEDOT:PSS polymer | |
| Ratio (wt:wt) of LiTFSI | 3.24 |
| to PEDOT:PSS polymer | |
| Parts by weight (“pbw”) | 4.04 |
| of LiTFSI in composition | |
| Parts by weight (“pbw”) | 1.25 |
| of PEDOT:PSS polymer | |
| in composition | |
| Parts by weight (“pbw”) | 94.71 |
| of liquid carrier in | |
| composition | |
| Wet thickness (μm) | 20 |
| Average resistance | 111.6 |
| (Ω/□) | |
| T (%) | 82.1 |
| Haze | 8.21 |

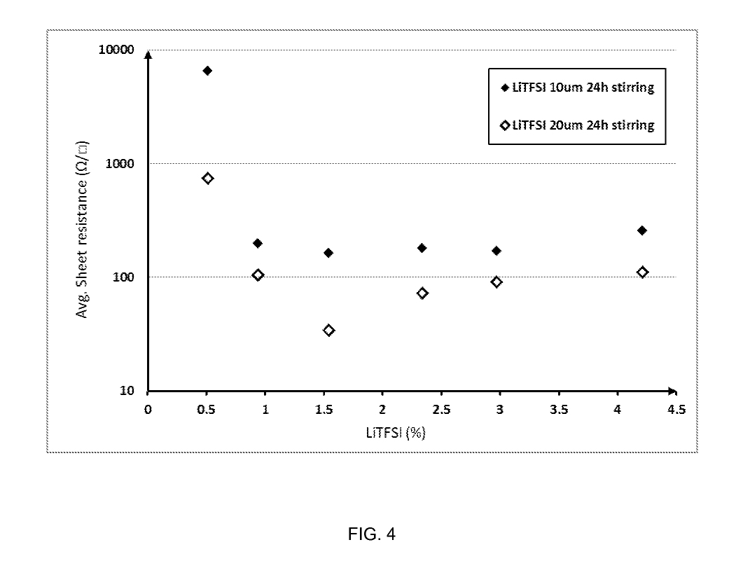

A plot of the average sheet resistance, expressed in Ohms per square (“ohms/square”), of the wet films formed from the coating compositions of Examples 20-31 versus the amount of lithium bis(trifluoromethanesulfonyl)imide (LiTFSI) used, expressed as percent by weight (“wt %”) with respect to the PEDOT:PSS dispersion, is shown in FIG. 4.

### Examples 32-35

The coating compositions of Examples 32-35 were made by adding a previously-prepared 82% (wt/wt) LiTFSI solution in the amounts set forth below in TABLE VI to 1 gram of a 1.3% aqueous dispersion of PEDOT:PSS (Clevios PH 1000, Heraeus) and mixing. The resulting compositions were then formed into the corresponding films using a bar coater. In Examples 32 and 33, the films were each formed to have a wet thickness of 10 μm. In Examples 34 and 35, the films were each formed to have a wet thickness of 20 μm. The sheet resistance of each film was measured at least four times using a four probe tester (Jandel RM3-AR) to arrive at an arithmetic average sheet resistance. The transmittance and haze of each film were measured. The amount of LiTFSI (expressed as grams (“g”) LiTFSI per 0.013 g PEDOT:PSS polymer) in each polymer/LiTFSI dispersion, the ratio (wt:wt) of LiTFSI to PEDOT:PSS polymer in the aqueous polymer/LiTFSI dispersion, parts by weight (“pbw”) of LiTFSI in each coating composition, parts by weight (“pbw”) of PEDOT:PSS polymer in each composition, parts by weight (“pbw”) of the liquid carrier in composition, wet thickness, and the average sheet resistance in ohms per square (Ω/□) are summarized for each of Examples 32-35 in TABLE VI below.

TABLE VI

| | Example # | | | |
|---|---|---|---|---|
| | 32 | 33 | 34 | 35 |
| Amount of LiTFSI | 0.65 | 2.77 | 0.65 | 2.77 |
| solution used with | | | | |
| respect to amount | | | | |
| of PEDOT:PSS | | | | |
| dispersion used (wt %) | | | | |
| Amount of LiTFSI (g) | 0.0053 | 0.0227 | 0.0053 | 0.0227 |
| per 0.013 g | | | | |
| PEDOT:PSS polymer | | | | |
| Ratio (wt:wt) of LiTFSI | 0.41:1 | 1.75:1 | 0.41:1 | 1.75:1 |
| to PEDOT:PSS polymer | | | | |
| Parts by weight (“pbw”) | 0.53 | 2.22 | 0.53 | 2.22 |
| of LiTFSI in composition | | | | |
| Parts by weight (“pbw”) | 1.29 | 1.27 | 1.29 | 1.27 |
| of PEDOT:PSS polymer | | | | |
| in composition | | | | |
| Parts by weight (“pbw”) | 98.18 | 96.50 | 98.18 | 96.50 |
| of liquid carrier in | | | | |
| composition | | | | |
| Wet thickness (μm) | 10 | 10 | 20 | 20 |
| Average resistance | 907.0 | 275.0 | 159.7 | 29.4 |
| (Ω/□) | | | | |

1. A mixture comprising:
(a) at least one electrically conductive polymer, and
(b) at least one salt comprising a sulfonylimide anion.

2. The mixture of claim 1 wherein the cation of the at least one salt comprising a sulfonylimide anion comprises a lithium cation, cation of formula VI′, cation of formula X, cation of formula XI, cation of formula XI′, cation of formula XII, or any combination thereof.

3. The mixture of claim 2 wherein the cation of the at least one salt comprising a sulfonylimide anion comprises lithium cation.

4.-8. (canceled)

9. The mixture of claim 1 wherein the electrically conductive polymer comprises a mixture of a polythiophene polymer and a polymeric acid dopant.

10. The mixture of claim 9, wherein the polythiophene polymer comprises two or more monomeric units according to structure (I.a) per molecule of the polymer: 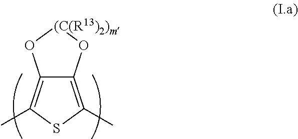
wherein:
each occurrence of R¹³ is independently H, alkyl, hydroxyl, heteroalkyl, alkenyl, heteroalkenyl, hydroxalkyl, amidosulfonate, benzyl, carboxylate, ether, ether carboxylate, ether sulfonate, ester sulfonate, or urethane, and
m′ is 2 or 3.
and the polymeric acid dopant comprises poly((styrene sulfonate).

11. A polymer composition, the composition comprising:
(a) a liquid carrier comprising water, at least one water miscible polar organic liquid, at least one ionic liquid or any combination thereof;
(b) at least one electrically conductive polymer, and
(c) at least one salt comprising a sulfonylimide anion.

12. The polymer composition of claim 11, wherein:
(a) the at least one water miscible polar organic liquid comprises dimethyl sulfoxide, and
(b) the at least one electrically conductive polymer comprises a mixture of:
(i) a polythiophene polymer that comprises two or more monomeric units according to structure (I.a) per molecule of the polymer: 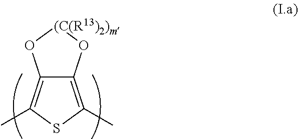
wherein:
each occurrence of R¹³ is independently H, alkyl, hydroxyl, heteroalkyl, alkenyl, heteroalkenyl, hydroxalkyl, amidosulfonate, benzyl, carboxylate, ether, ether carboxylate, ether sulfonate, ester sulfonate, or urethane, and m′ is 2 or 3, and
(ii) a polymeric acid dopant that comprises poly((styrene sulfonate).

13. The polymer composition of claim 11 wherein the cation of the at least one salt comprising a sulfonylimide anion comprises a lithium cation, cation of formula VI′, cation of formula X, cation of formula XI, cation of formula XI′, cation of formula XII, or any combination thereof.

14. The polymer composition of claim 13 wherein the cation of the at least one salt comprising a sulfonylimide anion comprises a lithium cation.

15.-19. (canceled)

20. A method for making the polymer composition according to claim 11, the method comprising:
(1a) dissolving or dispersing at least one electrically conductive polymer in a liquid carrier comprising water and/or at least one water miscible polar organic liquid and/or ionic liquid to form a mixture, and
(1b) adding to the mixture formed in step (1a) at least one salt comprising a sulfonylimide anion in a substantially dry form, thereby making the polymer composition.

21. The method of claim 20, wherein the at least one salt comprising a sulfonylimide anion in step (1b) is in a substantially dry form containing less than 5 wt % water, prior to being contacted with the mixture obtained in step (1a).

22. A method for making the polymer composition according to claim 11, the method comprising:
(2a) dissolving or dispersing at least one electrically conductive polymer in a first liquid carrier comprising water and/or at least one water miscible polar organic liquid and/or ionic liquid to form a first mixture,
(2b) dissolving or dispersing at least one salt comprising a sulfonylimide anion in a second liquid carrier comprising water and/or at least one water miscible polar organic liquid and/or ionic liquid to form a second mixture, and
(2c) contacting the first mixture formed in step (a) with the second mixture formed in step (2b), thereby making the polymer composition.

23. The method of claim 22, wherein the at least one salt comprising a sulfonylimide anion in step (2b) is dispersed in the second liquid carrier to form the second mixture, prior to being contacted with the first mixture.

24. The method of claim 22, wherein the second liquid carrier in step (2b) comprises at least one water miscible polar organic liquid, at least one ionic liquid or any combination thereof.

25. A method for making a polymer film, the method comprising:
(1) forming a layer of a polymer composition according to claim 11 on a substrate, and
(2) removing the liquid carrier from the layer, thereby making the polymer film.

26. (canceled)

27. A polymer film made by the method of claim 25.

28. A polymer film, gel, or foam comprising a mixture according to claim 1.

29. (canceled)

30. (canceled)

31. An electronic device, comprising:
(a) an anode layer,
(b) a cathode layer,
(c) an electroactive layer disposed between the anode layer and the cathode layer,
(d) optionally, a buffer layer,
(e) optionally, a hole transport layer, and
(f) optionally, an electron injection layer,
wherein at least one of the anode layer, the cathode layer, and, if present, the buffer layer comprises a mixture according to claim 1.

32. (canceled)

33. A battery comprising:
a first electrode,
at least one electrolyte, and
a second electrode,
wherein at least one of the first electrode, the electrolyte, and the second electrode comprises a mixture according to claim 1.

34. The battery of claim 33, wherein the battery has a rigid shape or a flexible, bendable, and/or twistable shape.

35. (canceled)
